(19) United States
(12) Patent Application Publication
(10) Pub. No.: US 2025/0112666 A1
(43) Pub. Date: Apr. 3, 2025

(54) RADIO FREQUENCY CIRCUIT

(71) Applicant: Murata Manufacturing Co., Ltd., Nagaokakyo-shi (JP)

(72) Inventors: Akira OGASAWARA, Nagaokakyo-shi (JP); Syuichi ONODERA, Nagaokakyo-shi (JP)

(73) Assignee: Murata Manufacturing Co., Ltd., Nagaokakyo-shi (JP)

(21) Appl. No.: 18/977,963

(22) Filed: Dec. 12, 2024

Related U.S. Application Data
(63) Continuation of application No. PCT/JP2023/018664, filed on May 18, 2023.

(30) Foreign Application Priority Data
Jul. 29, 2022 (JP) 2022-121819

(51) Int. Cl. H04B 1/44; H04B 1/401

(52) U.S. Cl. CPC H04B 1/44; H04B 1/401

(57) ABSTRACT

A radio frequency circuit includes a filter with a pass band including at least a part of a band (A) for TDD; a filter with a pass band including at least a part of the band (A); and a switch circuit that has (i) a first mode in which the filter is connected between an antenna connection terminal and a radio frequency input terminal, (ii) a second mode in which the filter is connected between the antenna connection terminal and a radio frequency output terminal, and (iii) a third mode in which the filters are connected in series between the antenna connection terminal and the radio frequency input terminal or between the antenna connection terminal and the radio frequency output terminal.

### CROSS-REFERENCE TO RELATED APPLICATIONS

This is a continuation application of PCT/JP2023/018664, filed on May 18, 2023, designating the United States of America, which is based on and claims priority to Japanese Patent Application No. JP 2022-121819 filed on Jul. 29, 2022. The entire contents of the above-identified applications, including the specifications, drawings and claims, are incorporated herein by reference in their entirety.

### TECHNICAL FIELD

The present disclosure relates to a radio frequency circuit.

### BACKGROUND ART

In mobile communication devices, such as mobile phones, with the advancement in multiband technologies, interference of signals has become a concern. Patent Document 1 discloses a radio frequency circuit that can operate in both of a carrier aggregation mode and a single mode.

### CITATION LIST

### Patent Document

Patent Document 1: Japanese Unexamined Patent Application Publication No. 2019-015402

### SUMMARY OF DISCLOSURE

### Technical Problem

However, with the related-art technology described above, there are cases in which attenuation outside of the pass band of a filter is not sufficient.

In view of the above problem, the present disclosure provides a radio frequency circuit that can improve attenuation characteristics.

### Solution to Problem

A radio frequency circuit according to an aspect of the present disclosure includes a first filter with a pass band including at least a part of a first band for time division duplex; a second filter with a pass band including at least a part of the first band; and a switch circuit that has (i) a first mode in which the first filter is connected between an antenna connection terminal and a radio frequency input terminal, (ii) a second mode in which the second filter is connected between the antenna connection terminal and a radio frequency output terminal, and (iii) a third mode in which the first filter and the second filter are connected in series between the antenna connection terminal and the radio frequency input terminal or between the antenna connection terminal and the radio frequency output terminal.

A radio frequency circuit according to an aspect of the present disclosure includes a first filter with a pass band including at least a part of a first band for time division duplex; a second filter with a pass band including at least a part of the first band; and first, second, and third switches. The first switch includes a first terminal connected to an antenna connection terminal, a second terminal connected to a first end of the first filter, a third terminal connected to a first end of the second filter, and a fourth terminal connected to the third switch. The second switch includes a fifth terminal connected to a second end of the first filter, a sixth terminal connected to a radio frequency input terminal, and a seventh terminal connected to the third switch. The third switch includes an eighth terminal connected to a second end of the second filter, a ninth terminal connected to a radio frequency output terminal, a tenth terminal connected to the seventh terminal of the second switch, and an eleventh terminal connected to the fourth terminal of the first switch.

A radio frequency circuit according to an aspect of the present disclosure includes a first filter with a pass band including at least a part of a first band for time division duplex; a second filter with a pass band including at least a part of the first band; and first and second switches. The first switch includes a first terminal connected to an antenna connection terminal, a second terminal connected to a first end of the first filter, a third terminal connected to a first end of the second filter, and a fourth terminal connected to the second switch. The second switch includes a fifth terminal connected to a second end of the first filter, a sixth terminal connected to a radio frequency input terminal, and a seventh terminal connected to the fourth terminal of the first switch. A second end of the second filter is connected to a radio frequency output terminal.

### Advantageous Effects of Disclosure

A radio frequency circuit according to an aspect of the present disclosure can improve attenuation characteristics.

### BRIEF DESCRIPTION OF DRAWINGS

FIG. 1 is a circuit diagram of a communication apparatus according to a first embodiment.

FIG. 2 is a diagram illustrating a path of a radio frequency signal in a first mode of a radio frequency circuit according to the first embodiment.

FIG. 3 is a diagram illustrating a path of a radio frequency signal in a second mode of the radio frequency circuit according to the first embodiment.

FIG. 4 is a diagram illustrating a path of a radio frequency signal in a third mode of the radio frequency circuit according to the first embodiment.

FIG. 5 is a circuit diagram of a communication apparatus according to a variation of the first embodiment.

FIG. 6 is a diagram illustrating a path of a radio frequency signal in a second mode of a radio frequency circuit according to the variation of the first embodiment.

FIG. 7 is a diagram illustrating a path of a radio frequency signal in a third mode of the radio frequency circuit according to the variation of the first embodiment.

FIG. 8 is a circuit diagram of a communication apparatus according to a second embodiment.

FIG. 9 is a diagram illustrating a path of a radio frequency signal in a first mode of a radio frequency circuit according to the second embodiment.

FIG. 10 is a diagram illustrating a path of a radio frequency signal in a second mode of the radio frequency circuit according to the second embodiment.

FIG. 11 is a diagram illustrating a path of a radio frequency signal in a third mode of the radio frequency circuit according to the second embodiment.

FIG. 12 is a circuit diagram of a communication apparatus according to a variation of the second embodiment.

FIG. 13 is a diagram illustrating a path of a radio frequency signal in a second mode of the radio frequency circuit according to the variation of the second embodiment.

FIG. 14 is a diagram illustrating a path of a radio frequency signal in a third mode of the radio frequency circuit according to the variation of the second embodiment.

FIG. 15 is a circuit diagram of a communication apparatus according to a third embodiment.

FIG. 16 is a diagram illustrating a path of a radio frequency signal in a first mode of a radio frequency circuit according to the third embodiment.

FIG. 17 is a diagram illustrating a path of a radio frequency signal in a second mode of the radio frequency circuit according to the third embodiment.

FIG. 18 is a diagram illustrating a path of a radio frequency signal in a third mode of the radio frequency circuit according to the third embodiment.

FIG. 19 is a circuit diagram of a communication apparatus according to a variation of the third embodiment.

FIG. 20 is a diagram illustrating a path of a radio frequency signal in a first mode of a radio frequency circuit according to the variation of the third embodiment.

FIG. 21 is a diagram illustrating a path of a radio frequency signal in a third mode of a radio frequency circuit according to the variation of the third embodiment.

### DESCRIPTION OF EMBODIMENTS

Embodiments of the present disclosure are described in detail below with reference to the drawings. Each of the embodiments described below represents a general or specific example. Values, shapes, materials, components, and the layouts and connection configurations of the components described in the embodiments below are just examples and are not intended to limit the present disclosure.

Each of the drawings is a schematic diagram in which components are emphasized or omitted and the ratios between the components are adjusted to facilitate the understanding of the present disclosure. That is, components in each of the drawings are not necessarily illustrated accurately; and the shapes, the positional relationships, and the ratios of the components may differ from the actual shapes, positional relationships, and ratios. The same reference number is assigned to substantially the same components in the drawings, and repeated descriptions of those components may be omitted or simplified.

In the descriptions below, “connected” not only indicates that circuit elements are directly connected to each other with a connection terminal and/or a wire conductor but also indicates that the circuit elements are electrically connected to each other via another circuit element. Also, “connected between A and B” indicates that a component is disposed between A and B and connected to both of A and B and indicates that a component is connected in series with A and B in a path connecting A and B.

Also, in the descriptions below, “transmission band” refers to a frequency band used for transmission by a communication apparatus. “Reception band” refers to a frequency band used for reception by a communication apparatus. For example, in a frequency division duplex (FDD) band, different frequency bands are used for a transmission band and a reception band; and in a time division duplex (TDD) band, the same frequency band is used for a transmission band and a reception band. Particularly, assuming a communication apparatus functions as user equipment (UE) in a cellular communication system, in an FDD band, an uplink operation band is used as a transmission band, and a downlink operation band is used as a reception band. In contrast, assuming a communication apparatus functions as a base station (BS) in a cellular communication system, in an FDD band, a downlink operation band is used as a transmission band, and an uplink operation band is used as a reception band.

Also, in the descriptions below, “terminal” indicates a point at which a conductor in an element ends. Here, assuming the impedance of a conductor functioning as a path between elements is sufficiently low, a terminal is interpreted not only as a point at which a conductor in an element ends but also as any point on the path between the elements connected to the point or as the entire path.

### First Embodiment

A first embodiment is described below. A communication apparatus 5 according to the present embodiment corresponds to user equipment in a cellular communication system, such as a mobile phone, a smartphone, a tablet computer, or a wearable device. The communication apparatus 5 may also be an Internet of Things (IoT) sensor device, a medical/healthcare device, a vehicle, an unmanned aerial vehicle (UAV) (so-called drone), or an automated guided vehicle (AGV). Furthermore, the communication apparatus 5 may be used as a base station in a cellular communication system.

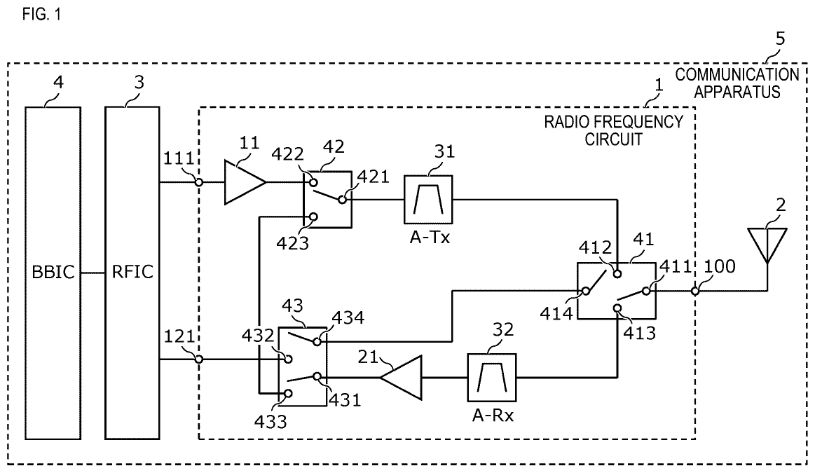

Circuit configurations of the communication apparatus 5 and a radio frequency circuit 1 of the present embodiment are described with reference to FIG. 1. FIG. 1 is a circuit diagram of the communication apparatus 5 according to the present embodiment.

Here, FIG. 1 illustrates an exemplary circuit configuration, and the communication apparatus 5 and the radio frequency circuit 1 may be implemented by using any of various types of circuit implementations and circuit technologies. Accordingly, descriptions of the communication apparatus 5 and the radio frequency circuit 1 provided below should not be interpreted restrictively.

### [1.1 Circuit Configuration of Communication Apparatus 5]

First, a circuit configuration of the communication apparatus 5 according to the present embodiment is described with reference to FIG. 1. The communication apparatus 5 includes the radio frequency circuit 1, an antenna 2, a radio frequency integrated circuit (RFIC) 3, and a baseband integrated circuit (BBIC) 4.

The radio frequency circuit 1 transmits radio frequency signals between the antenna 2 and the RFIC 3. The internal configuration of the radio frequency circuit 1 is described later.

The antenna 2 is connected to an antenna connection terminal 100 of the radio frequency circuit 1. The antenna 2 receives a radio frequency signal from the radio frequency circuit 1 and outputs the received radio frequency signal to the outside of the communication apparatus 5. Also, the antenna 2 receives a radio frequency signal from the outside of the communication apparatus 5 and transmits the received radio frequency signal to the radio frequency circuit 1. The antenna 2 is not necessarily included in the communication apparatus 5. Also, the communication apparatus 5 may include one or more antennas in addition to the antenna 2.

The RFIC 3 is an example of a signal processing circuit that processes radio frequency signals. Specifically, the RFIC 3 performs signal processing, such as up-converting, on a transmission signal input from the BBIC 4 and outputs a radio frequency transmission signal generated by the signal processing to the radio frequency circuit 1. Also, the RFIC 3 performs signal processing, such as down-converting, on a radio frequency reception signal input via a reception path of the radio frequency circuit 1 and outputs a reception signal generated by the signal processing to the BBIC 4. The RFIC 3 may include a control unit that controls, for example, switches and amplifiers of the radio frequency circuit 1. Some or all of the functions of the control unit of the RFIC 3 may be provided outside of the RFIC 3 and included in, for example, the BBIC 4 or the radio frequency circuit 1.

The BBIC 4 is a baseband signal processing circuit that performs signal processing using an intermediate frequency band that is lower than the frequency of radio frequency signals transmitted by the radio frequency circuit 1. Examples of signals processed by the BBIC 4 include an image signal for displaying an image and/or a voice signal for a call via a speaker. The BBIC 4 is not necessarily included in the communication apparatus 5.

### [1.2 Circuit Configuration of Radio Frequency Circuit 1]

Next, the radio frequency circuit 1 according to the present embodiment is described with reference to FIG. 1. The radio frequency circuit 1 includes a power amplifier 11, a low-noise amplifier 21, filters 31 and 32, switches 41 to 43, an antenna connection terminal 100, a radio frequency input terminal 111, and a radio frequency output terminal 121.

The antenna connection terminal 100 is an external connection terminal of the radio frequency circuit 1, supplies a transmission signal to the antenna 2, and receives a reception signal from the antenna 2. The antenna connection terminal 100 is connected to the antenna 2 outside of the radio frequency circuit 1 and connected to the switch 41 inside of the radio frequency circuit 1.

The radio frequency input terminal 111 is an external connection terminal of the radio frequency circuit 1 and receives transmission signals from the outside of the radio frequency circuit 1. The radio frequency input terminal 111 is connected to the RFIC 3 outside of the radio frequency circuit 1 and connected to the input end of the power amplifier 11 inside of the radio frequency circuit 1.

The radio frequency output terminal 121 is an external connection terminal of the radio frequency circuit 1 and supplies reception signals to the outside of the radio frequency circuit 1. The radio frequency output terminal 121 is connected to the RFIC 3 outside of the radio frequency circuit 1 and connected to the switch 43 inside of the radio frequency circuit 1.

The power amplifier 11 is connected between the radio frequency input terminal 111 and the antenna connection terminal 100. Specifically, the input end of the power amplifier 11 is connected to the radio frequency input terminal 111, and the output end of the power amplifier 11 is connected to the antenna connection terminal 100 via the switch 42, the filter 31, and the switch 41. With this connection configuration, the power amplifier 11 can amplify an input signal (transmission signal) received from the RFIC 3 via the radio frequency input terminal 111 based on power supplied from a power source (not shown). The power amplifier 11 is not necessarily included in the radio frequency circuit 1.

The low-noise amplifier 21 is connected between the antenna connection terminal 100 and the radio frequency output terminal 121. Specifically, the input end of the low-noise amplifier 21 is connected to the antenna connection terminal 100 via the filter 32 and the switch 41. The output end of the low-noise amplifier 21 is connected to the radio frequency output terminal 121 via the switch 43. With this connection configuration, the low-noise amplifier 21 can amplify a reception signal in a band A received from the antenna 2 via the antenna connection terminal 100 based on power supplied from the power source (not shown). The low-noise amplifier 21 is not necessarily included in the radio frequency circuit 1.

The filter 31 (A-Tx) is an example of a first filter and has a pass band including a transmission band in the band A. The filter 31 is connected between the radio frequency input terminal 111 and the antenna connection terminal 100 and between the antenna connection terminal 100 and the radio frequency output terminal 121. Specifically, a first end of the filter 31 is connected to the antenna connection terminal 100 via the switch 41 and is also connected to the radio frequency output terminal 121 via the switches 41 and 43. A second end of the filter 31 is connected to the radio frequency input terminal 111 via the switch 42 and the power amplifier 11 and is also connected to the antenna connection terminal 100 via the switches 42 and 43, the low-noise amplifier 21, the filter 32, and the switch 41.

The filter 32 (A-Rx) is an example of a second filter and has a pass band including a reception band in the band A. The filter 32 is connected between the antenna connection terminal 100 and the radio frequency output terminal 121. Specifically, a first end of the filter 32 is connected to the antenna connection terminal 100 via the switch 41. A second end of the filter 32 is connected to the radio frequency output terminal 121 via the low-noise amplifier 21 and the switch 43 and is also connected to the radio frequency output terminal 121 via the low-noise amplifier 21, the switches 43 and 42, the filter 31, and the switches 41 and 43.

The band A is an example of a first band and is a frequency band for TDD in a communication system constructed using a radio access technology (RAT). The band A is predefined by, for example, a standardization organization (e.g., 3rd Generation Partnership Project (3GPP) (registered trademark) or Institute of Electrical and Electronics Engineers (IEEE)). Examples of communication systems include a 5th Generation New Radio (5G NR) system, a Long Term Evolution (LTE) system, and a wireless local area network (WLAN) system.

As a non-limiting example, Band 40 for LTE or n40 for 5G NR may be used as the band A.

The switch 41 is an example of a first switch and constitutes a part of a switch circuit. The switch 41 includes terminals 411 to 414. The terminal 411 is an example of a first terminal and is connected to the antenna connection terminal 100. The terminal 412 is an example of a second terminal and is connected to the first end of the filter 31. The terminal 413 is an example of a third terminal and is connected to the first end of the filter 32. The terminal 414 is an example of a fourth terminal and is connected to the switch 43.

With this connection configuration, the switch 41 can selectively connect the terminal 411 to the terminals 412 and 413 based on, for example, a control signal from the RFIC 3. In other words, the switch 41 can exclusively connect the terminal 411 to one of the terminals 412 and 413. Also, the switch 41 can connect the terminal 414 to the terminal 412.

The switch 42 is an example of a second switch and constitutes a part of the switch circuit. The switch 42 includes terminals 421 to 423. The terminal 421 is an example of a fifth terminal and is connected to the second end of the filter 31. The terminal 422 is an example of a sixth terminal and is connected to the output end of the power amplifier 11. The terminal 423 is an example of a seventh terminal and is connected to the switch 43.

With this connection configuration, the switch 42 can selectively connect the terminal 421 to the terminals 422 and 423 based on, for example, a control signal from the RFIC 3. In other words, the switch 42 can exclusively connect the terminal 421 to one of the terminals 422 and 423.

The switch 43 is an example of a third switch and constitutes a part of the switch circuit. The switch 43 includes terminals 431 to 434. The terminal 431 is an example of an eighth terminal and is connected to the second end of the filter 32 via the low-noise amplifier 21. The terminal 432 is an example of a ninth terminal and is connected to the radio frequency output terminal 121. The terminal 433 is an example of a tenth terminal and is connected to the terminal 423 of the switch 42. The terminal 434 is an example of an eleventh terminal and is connected to the terminal 414 of the switch 41.

With this connection configuration, the switch 43 can selectively connect the terminal 431 to the terminals 432 and 433 based on, for example, a control signal from the RFIC 3. In other words, the switch 43 can exclusively connect the terminal 431 to one of the terminals 432 and 433. Also, the switch 43 can connect the terminal 434 to the terminal 432.

The switch circuit including the switches 41 to 43 may be implemented in one semiconductor integrated circuit or in multiple integrated circuits. The switch circuit may be implemented by any appropriate implementation method.

### [1.3 Modes of Radio Frequency Circuit 1]

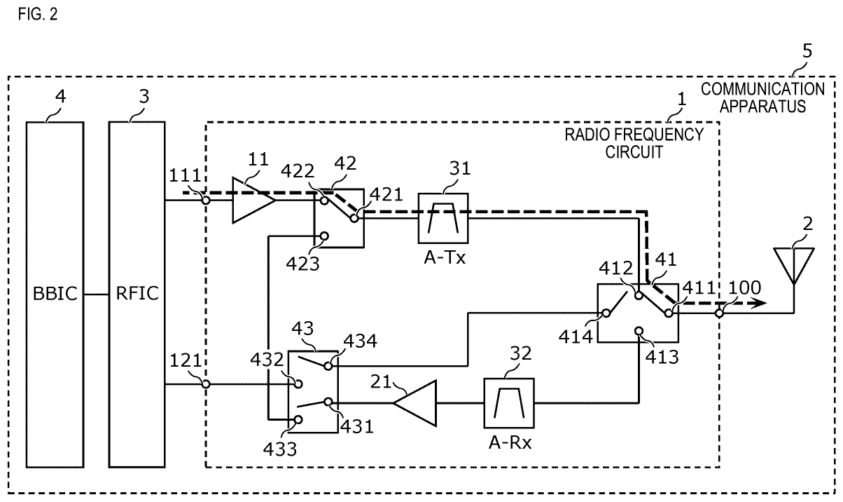

Next, multiple modes of the radio frequency circuit 1 are described with reference to FIGS. 2 to 4.

First, a first mode of the radio frequency circuit 1 is described with reference to FIG. 2. FIG. 2 illustrates a path of a radio frequency signal in the first mode of the radio frequency circuit 1 according to the present embodiment. In FIG. 2, a dotted arrow represents a transmission path of a radio frequency signal.

As illustrated in FIG. 2, in the first mode, the filter 31 is connected, but the filter 32 is not connected, between the antenna connection terminal 100 and the radio frequency input terminal 111. Specifically, in the switch 41, the terminal 411 is connected to the terminal 412 but is not connected to the terminal 413. Also, the terminal 414 is not connected to the terminal 412. In the switch 42, the terminal 421 is connected to the terminal 422 but is not connected to the terminal 423. In the switch 43, no terminal is connected to any other terminal.

In this mode, a transmission signal in the band A received from the RFIC 3 via the radio frequency input terminal 111 is transmitted to the antenna connection terminal 100 via the power amplifier 11, the switch 42, the filter 31, and the switch 41.

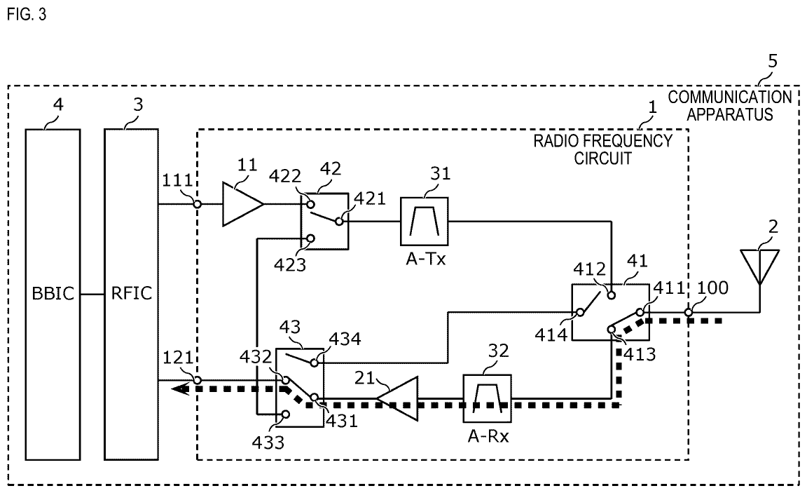

Next, a second mode of the radio frequency circuit 1 is described with reference to FIG. 3. FIG. 3 illustrates a path of a radio frequency signal in the second mode of the radio frequency circuit 1 according to the present embodiment. In FIG. 3, a dotted arrow represents a reception path of a radio frequency signal.

As illustrated in FIG. 3, in the second mode, the filter 32 is connected, but the filter 31 is not connected, between the antenna connection terminal 100 and the radio frequency output terminal 121. Specifically, in the switch 41, the terminal 411 is connected to the terminal 413 but is not connected to the terminal 412. Also, the terminal 414 is not connected to the terminal 412. In the switch 42, no terminal is connected to any other terminal. In the switch 43, the terminal 431 is connected to the terminal 432 but is not connected to the terminal 433. Also, the terminal 434 is not connected to the terminal 432.

In this mode, a reception signal in the band A received from the antenna 2 via the antenna connection terminal 100 is transmitted to the radio frequency output terminal 121 via the switch 41, the filter 32, the low-noise amplifier 21, and the switch 43.

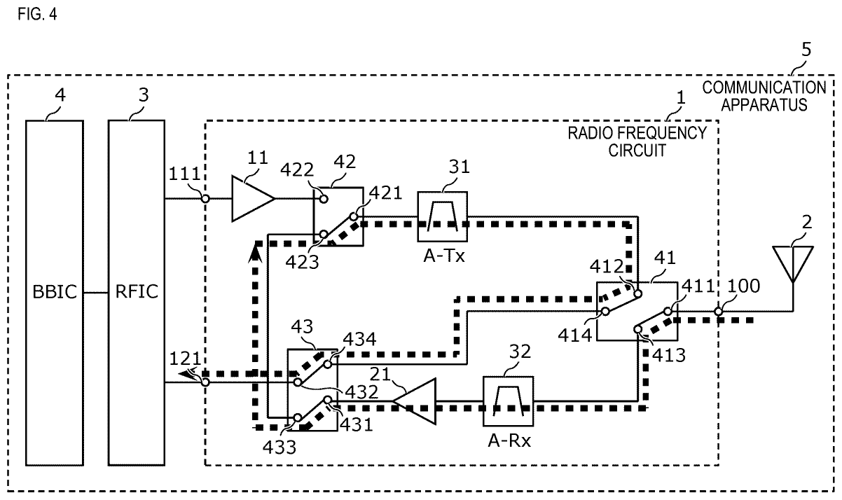

Finally, a third mode of the radio frequency circuit 1 is described with reference to FIG. 4. FIG. 4 illustrates a path of a radio frequency signal in the third mode of the radio frequency circuit 1 according to the present embodiment. In FIG. 4, a dotted arrow represents a reception path of a radio frequency signal.

As illustrated in FIG. 4, in the third mode, the filters 31 and 32 are connected in series between the antenna connection terminal 100 and the radio frequency output terminal 121. Specifically, in the switch 41, the terminal 411 is connected to the terminal 413 but is not connected to the terminal 412. Also, the terminal 414 is connected to the terminal 412. In the switch 42, the terminal 421 is connected to the terminal 423 but is not connected to the terminal 422. In the switch 43, the terminal 431 is connected to the terminal 433 but is not connected to the terminal 432. Also, the terminal 434 is connected to the terminal 432.

In this mode, a reception signal in the band A received from the antenna 2 via the antenna connection terminal 100 is transmitted to the radio frequency output terminal 121 via the switch 41, the filter 32, the low-noise amplifier 21, the switches 43 and 42, the filter 31, and the switches 41 and 43.

The second mode and the third mode for receiving signals in the band A are switched by the RFIC 3 based on, for example, a reception signal level in the band A. The second mode and the third mode may also be switched based on factors other than the reception signal level in the band A. For example, the second mode and the third mode may be switched based on whether the band A is used simultaneously with another band for communication. Also, the second mode and the third mode may be switched based on the power class or average output power of the other band.

### [1.4 Effects]

As described above, the radio frequency circuit 1 according to the present embodiment includes the filter 31 with a pass band including at least a part of the band A for TDD, the filter 32 with a pass band including at least a part of the band A, and the switch circuit that has (i) the first mode in which the filter 31 is connected between the antenna connection terminal 100 and the radio frequency input terminal 111, (ii) the second mode in which the filter 32 is connected between the antenna connection terminal 100 and the radio frequency output terminal 121, and (iii) the third mode in which the filters 31 and 32 are connected in series between the antenna connection terminal 100 and the radio frequency input terminal 111 or between the antenna connection terminal 100 and the radio frequency output terminal 121.

With this configuration, a signal in the band A for TDD can be received in the third mode in which the filter 31 for transmission and the filter 32 for reception are connected in series to the reception path. Compared with a case in which a signal in the band A is received in the second mode where the filter 31 is not connected to the reception path, this configuration makes it possible to improve the attenuation characteristics outside of the band A. Also, with the above configuration, it is possible to receive a signal in the band A in the second mode where the filter 31 is not connected to the reception path. This in turn makes it possible to prevent an increase in signal loss due to the use of the two filters 31 and 32. Furthermore, the above configuration makes it possible to share the filter 31 in the first mode (transmission) and the third mode (reception) and thereby makes it possible to prevent an increase in the number of filters.

Also, for example, in the radio frequency circuit 1 according to the present embodiment, the switch circuit may include the switches 41 to 43; the switch 41 may include the terminal 411 connected to the antenna connection terminal 100, the terminal 412 connected to the first end of the filter 31, the terminal 413 connected to the first end of the filter 32, and the terminal 414 connected to the switch 43; the switch 42 may include the terminal 421 connected to the second end of the filter 31, the terminal 422 connected to the radio frequency input terminal 111, and the terminal 423 connected to the switch 43; and the switch 43 may include the terminal 431 connected to the second end of the filter 32, the terminal 432 connected to the radio frequency output terminal 121, the terminal 433 connected to the terminal 423 of the switch 42, and the terminal 434 connected to the terminal 414 of the switch 41.

With this configuration, it is possible to switch between the first mode, the second mode, and the third mode by using the three switches 41 to 43. Particularly, because the terminal 433 of the switch 43 is connected to the terminal 423 of the switch 42, it is possible to enable a reception signal in the band A, which has passed through the filter 32 and has been amplified by the low-noise amplifier 21, to pass through the filter 31. Accordingly, compared with a case in which a reception signal not amplified by the low-noise amplifier 21 passes through the filter 31, this configuration makes it possible to suppress the degradation of a noise figure (NF) resulting from the signal loss at the filter 31.

Also, for example, in the radio frequency circuit 1 according to the present embodiment, the switch 41 may be capable of connecting the terminal 411 to the terminals 412 and 413 and connecting the terminal 414 to the terminal 412; the switch 42 may be capable of connecting the terminal 421 to the terminals 422 and 423; and the switch 43 may be capable of connecting the terminal 431 to the terminals 432 and 433 and connecting the terminal 434 to the terminal 432.

With this configuration, it is possible to switch between the first mode, the second mode, and the third mode by using the three switches 41 to 43. Particularly, the switch 43 can connect the terminal 431 to the terminal 433, and the switch 42 can connect the terminal 421 to the terminal 423. This enables a reception signal in the band A, which has passed through the filter 32 and has been amplified by the low-noise amplifier 21, to pass through the filter 31 and thereby makes it possible to suppress the degradation of NF resulting from the signal loss at the filter 31.

Also, for example, in the radio frequency circuit 1 according to the present embodiment, in the first mode, the switch 41 may connect the terminal 411 to the terminal 412, and the switch 42 may connect the terminal 421 to the terminal 422; in the second mode, the switch 41 may connect the terminal 411 to the terminal 413, and the switch 43 may connect the terminal 431 to the terminal 432; and in the third mode, the switch 41 may connect the terminal 411 to the terminal 413 and connect the terminal 414 to the terminal 412, the switch 42 may connect the terminal 421 to the terminal 423, and the switch 43 may connect the terminal 431 to the terminal 433 and connect the terminal 434 to the terminal 432.

With this configuration, in the third mode, the terminal 431 is connected to the terminal 433 in the switch 43, and the terminal 421 is connected to the terminal 423 in the switch 42. Accordingly, in the third mode, a reception signal in the band A, which has passed through the filter 32 and has been amplified by the low-noise amplifier 21, is enabled to pass through the filter 31. This in turn makes it possible to suppress the degradation of NF resulting from the signal loss at the filter 31.

Also, for example, in the radio frequency circuit 1 according to the present embodiment, (i) in the first mode, the switch circuit does not necessarily connect the filter 32 between the antenna connection terminal 100 and the radio frequency input terminal 111, and (ii) in the second mode, the switch circuit does not necessarily connect the filter 31 between the antenna connection terminal 100 and the radio frequency output terminal 121.

With this configuration, the signal loss can be reduced more in the second mode than in the third mode.

From a different point of view, the radio frequency circuit 1 according to the present embodiment includes the filter 31 with a pass band including at least a part of the band A for TDD, the filter 32 with a pass band including at least a part of the band A, and the switches 41 to 43. The switch 41 includes the terminal 411 connected to the antenna connection terminal 100, the terminal 412 connected to the first end of the filter 31, the terminal 413 connected to the first end of the filter 32, and the terminal 414 connected to the switch 43. The switch 42 includes the terminal 421 connected to the second end of the filter 31, the terminal 422 connected to the radio frequency input terminal 111, and the terminal 423 connected to the switch 43. The switch 43 includes the terminal 431 connected to the second end of the filter 32, the terminal 432 connected to the radio frequency output terminal 121, the terminal 433 connected to the terminal 423 of the switch 42, and the terminal 434 connected to the terminal 414 of the switch 41.

With this configuration, by using the three switches 41 to 43, (i) the filter 31 can be connected between the antenna connection terminal 100 and the radio frequency input terminal 111, (ii) the filter 32 can be connected, without connecting the filter 31, between the antenna connection terminal 100 and the radio frequency output terminal 121, and (iii) the filters 31 and 32 can be connected in series between the antenna connection terminal 100 and the radio frequency output terminal 121.

Particularly, because the terminal 433 of the switch 43 is connected to the terminal 423 of the switch 42, it is possible to enable a reception signal in the band A, which has passed through the filter 32 and has been amplified by the low-noise amplifier 21, to pass through the filter 31.

Accordingly, compared with a case in which a reception signal not amplified by the low-noise amplifier 21 passes through the filter 31, the above configuration can suppress the degradation of NF resulting from signal loss at the filter 31.

### Variation of First Embodiment

Next, a variation of the first embodiment is described. A radio frequency circuit 1A according to the present variation differs mainly from the radio frequency circuit 1 according to the first embodiment in that the radio frequency circuit 1A supports, in addition to the band A, a band B that can be used simultaneously with the band A for communication. A communication apparatus 5A and the radio frequency circuit 1A according to the present variation are described below with reference to the drawings, focusing on the differences from the communication apparatus 5 and the radio frequency circuit 1 according to the first embodiment.

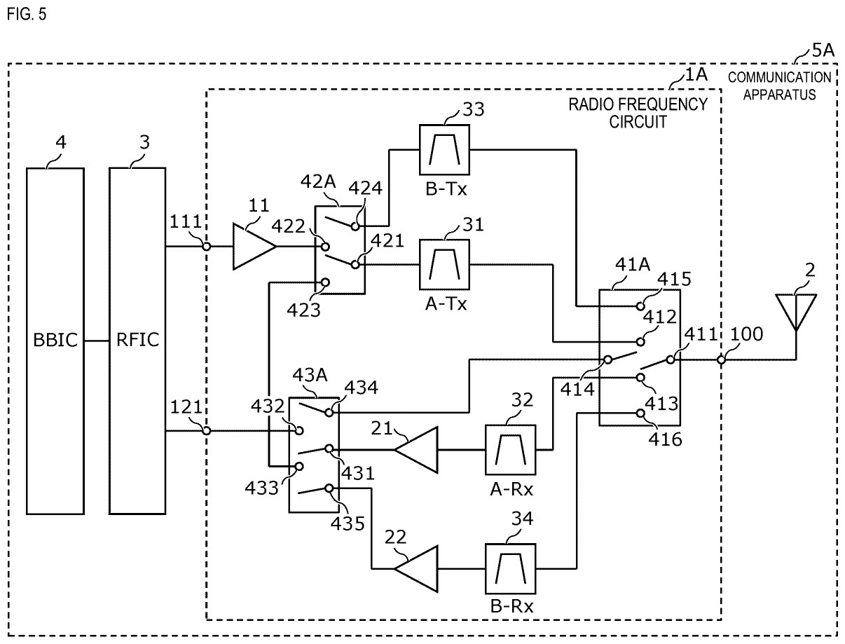

FIG. 5 is a circuit diagram of the communication apparatus 5A according to the present variation. Here, FIG. 5 illustrates an exemplary circuit configuration, and the communication apparatus 5A and the radio frequency circuit 1A may be implemented by using any of various types of circuit implementations and circuit technologies. Accordingly, descriptions of the communication apparatus 5A and the radio frequency circuit 1A provided below should not be interpreted restrictively.

The communication apparatus 5A according to the present variation differs from the communication apparatus 5 only in that the communication apparatus 5A includes the radio frequency circuit 1A instead of the radio frequency circuit 1. Therefore, descriptions of the communication apparatus 5A are omitted.

### [1.5 Circuit Configuration of Radio Frequency Circuit 1A]

The radio frequency circuit 1A according to the present variation includes a power amplifier 11, low-noise amplifiers 21 and 22, filters 31 to 34, switches 41A to 43A, an antenna connection terminal 100, a radio frequency input terminal 111, and a radio frequency output terminal 121.

The low-noise amplifier 22 is connected between the antenna connection terminal 100 and the radio frequency output terminal 121. Specifically, the input end of the low-noise amplifier 22 is connected to the antenna connection terminal 100 via the filter 34 and the switch 41A. The output end of the low-noise amplifier 22 is connected to the radio frequency output terminal 121 via the switch 43A. With this connection configuration, the low-noise amplifier 22 can amplify a reception signal in the band B received from the antenna 2 via the antenna connection terminal 100 based on power supplied from a power source (not shown). The low-noise amplifier 22 is not necessarily included in the radio frequency circuit 1A.

The filter 33 (B-Tx) is an example of a third filter with a pass band including a transmission band in the band B. The filter 33 is connected between the radio frequency input terminal 111 and the antenna connection terminal 100. Specifically, a first end of the filter 33 is connected to the antenna connection terminal 100 via the switch 41A. A second end of the filter 33 is connected to the radio frequency input terminal 111 via the switch 42A and the power amplifier 11.

The filter 34 (B-Rx) has a pass band including a reception band in the band B. The filter 34 is connected between the antenna connection terminal 100 and the radio frequency output terminal 121. Specifically, a first end of the filter 34 is connected to the antenna connection terminal 100 via the switch 41A. A second end of the filter 34 is connected to the radio frequency output terminal 121 via the low-noise amplifier 22 and the switch 43A.

The band B is an example of a second band that is a frequency band for a communication system constructed using RAT. The band B is a frequency band that can be used simultaneously with the band A for communication and is predefined by, for example, a standardization organization. As a non-limiting example, Band 41 for LTE or n41 for 5G NR may be used as the band B.

The switch 41A is an example of a first switch and constitutes a part of a switch circuit. The switch 41A includes terminals 411 to 416. The terminal 411 is an example of a first terminal and is connected to the antenna connection terminal 100. The terminal 412 is an example of a second terminal and is connected to a first end of the filter 31. The terminal 413 is an example of a third terminal and is connected to a first end of the filter 32. The terminal 414 is an example of a fourth terminal and is connected to the switch 43A. The terminal 415 is an example of a twelfth terminal and is connected to the first end of the filter 33. The terminal 416 is connected to the first end of the filter 34.

With this connection configuration, based on, for example, a control signal from the RFIC 3, the switch 41A can selectively connect the terminal 411 to the terminals 412 and 413 and can selectively connect the terminal 411 to the terminals 415 and 416. Also, the switch 41A can connect the terminal 414 to the terminal 412.

The switch 42A is an example of a second switch and constitutes a part of the switch circuit. The switch 42A includes terminals 421 to 424. The terminal 421 is an example of a fifth terminal and is connected to a second end of the filter 31. The terminal 422 is an example of a sixth terminal and is connected to the output end of the power amplifier 11. The terminal 423 is an example of a seventh terminal and is connected to the switch 43A. The terminal 424 is an example of a thirteenth terminal and is connected to the second end of the filter 33.

With this connection configuration, the switch 42A can selectively connect the terminal 422 to the terminals 421 and 424 based on, for example, a control signal from the RFIC 3. Also, the switch 42A can connect the terminal 421 to the terminal 423.

The switch 43A is an example of a third switch and constitutes a part of the switch circuit. The switch 43A includes terminals 431 to 435. The terminal 431 is an example of an eighth terminal and is connected to a second end of the filter 32 via the low-noise amplifier 21. The terminal 432 is an example of a ninth terminal and is connected to the radio frequency output terminal 121. The terminal 433 is an example of a tenth terminal and is connected to the terminal 423 of the switch 42A. The terminal 434 is an example of an eleventh terminal and is connected to the terminal 414 of the switch 41A. The terminal 435 is connected to the second end of the filter 34 via the low-noise amplifier 22.

With this connection configuration, the switch 43A can selectively connect the terminal 432 to the terminals 431, 434, and 435 based on, for example, a control signal from the RFIC 3. Also, the switch 43A can connect the terminal 433 to the terminal 431.

The low-noise amplifier 22 and the filter 34 are not necessarily included in the radio frequency circuit 1A. In this case, the switch 41A does not have to include the terminal 416, and the switch 43A does not have to include the terminal 435.

The switch circuit including the switches 41A to 43A may be implemented in one semiconductor integrated circuit or in multiple integrated circuits. The switch circuit may be implemented by any appropriate implementation method.

### [1.6 Modes of Radio Frequency Circuit 1A]

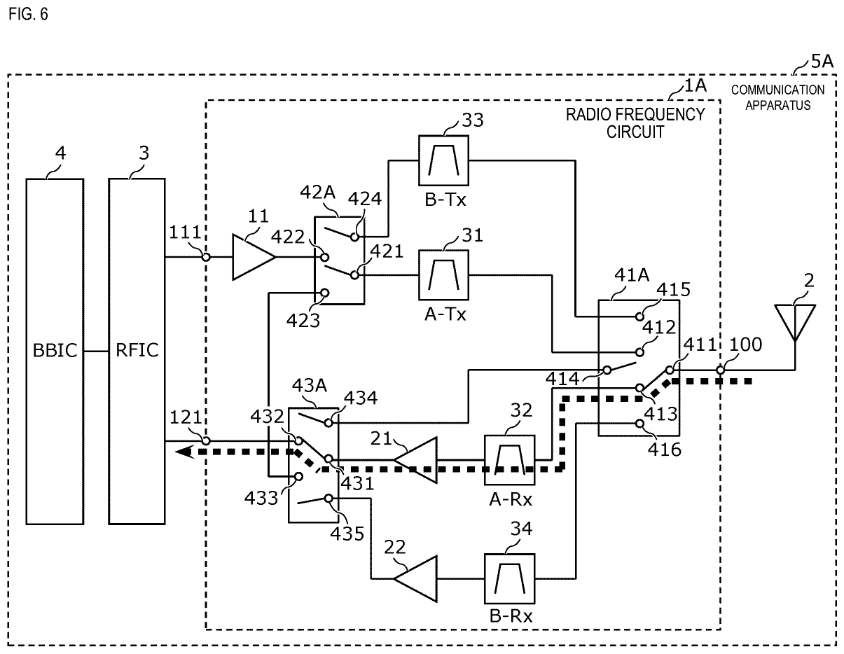

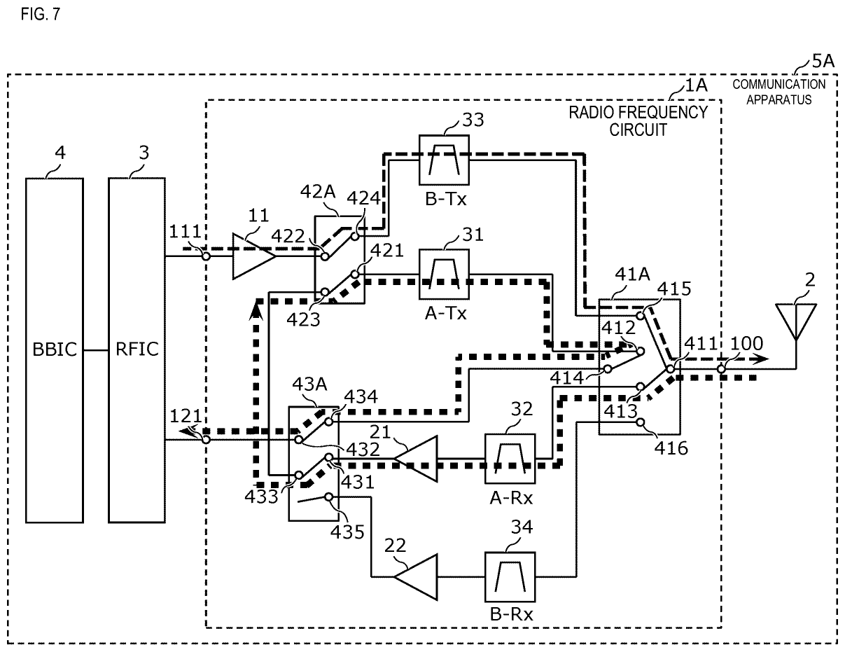

Next, a second mode and a third mode of the radio frequency circuit 1A are described with reference to FIGS. 6 and 7. FIG. 6 illustrates a path of a radio frequency signal in the second mode of the radio frequency circuit 1A according to the present variation. FIG. 7 illustrates a path of a radio frequency signal in the third mode of the radio frequency circuit 1A according to the present variation. In FIGS. 6 and 7, each dotted arrow represents a transmission path or a reception path of a radio frequency signal.

As illustrated in FIG. 6, the second mode is used in the radio frequency circuit 1A assuming a signal in the band A is received and no signal in the band B is transmitted. In the second mode, the filter 32 is connected, but the filter 31 is not connected, between the antenna connection terminal 100 and the radio frequency output terminal 121. Specifically, in the switch 41A, the terminal 411 is connected to the terminal 413 but is not connected to the terminals 412, 415, and 416. Also, the terminal 414 is not connected to the terminal 412. In the switch 43A, the terminal 431 is connected to the terminal 432 but is not connected to the terminal 433. Also, the terminals 434 and 435 are not connected to the terminal 432.

In this mode, a reception signal in the band A received from the antenna 2 via the antenna connection terminal 100 is transmitted to the radio frequency output terminal 121 via the switch 41A, the filter 32, the low-noise amplifier 21, and the switch 43A.

As illustrated in FIG. 7, the third mode is used in the radio frequency circuit 1A assuming a signal in the band A is received and a signal in the band B is transmitted. In the third mode, the filters 31 and 32 are connected in series between the antenna connection terminal 100 and the radio frequency output terminal 121. Also, the filter 33 is connected between the antenna connection terminal 100 and the radio frequency input terminal 111.

Specifically, in the switch 41A, the terminal 411 is connected to the terminals 413 and 415 but is not connected to the terminals 412 and 416. Also, the terminal 414 is connected to the terminal 412. In the switch 42A, the terminal 421 is connected to the terminal 423 but is not connected to the terminal 422. Also, the terminal 424 is connected to the terminal 422. In the switch 43A, the terminal 431 is connected to the terminal 433 but is not connected to the terminal 432. Also, the terminal 434 is connected to the terminal 432.

In this mode, a reception signal in the band A received from the antenna 2 via the antenna connection terminal 100 is transmitted to the radio frequency output terminal 121 via the switch 41A, the filter 32, the low-noise amplifier 21, the switches 43A and 42A, the filter 31, and the switches 41A and 43A. Also, a transmission signal in the band B received from the RFIC 3 via the radio frequency input terminal 111 is transmitted to the antenna connection terminal 100 via the power amplifier 11, the switch 42A, the filter 33, and the switch 41A.

Thus, in the present variation, the second mode (FIG. 6) is used assuming a signal in the band A is received and no signal in the band B is transmitted. On the other hand, the third mode (FIG. 7) is used assuming a signal in the band A is received and a signal in the band B is transmitted. That is, in the radio frequency circuit 1A, (i) the second mode is used assuming reception in the band A is performed solely, and (ii) the third mode is used assuming reception in the band A and transmission in the band B are performed simultaneously.

In the radio frequency circuit 1A, as in FIG. 2, the first mode may also be used to perform only transmission in the band A. Also, a mode for performing only transmission in the band B and/or a mode for performing only reception in the band B may be used. Furthermore, a mode for simultaneously performing transmission in the band A and reception in the band B may be used.

### [1.7 Effects]

Also, for example, the radio frequency circuit 1A according to the present variation further includes the filter 33 with a pass band including at least a part of the band B that can be used simultaneously with the band A for communication, the switch 41A further includes the terminal 415 that is connected to the first end of the filter 33, and the switch 42A further includes the terminal 424 that is connected to the second end of the filter 33.

With this configuration, the radio frequency circuit 1A can support, in addition to the band A, the band B that can be used simultaneously with the band A for communication.

Also, for example, in the radio frequency circuit 1A according to the present variation, assuming a signal in the band A is received and no signal in the band B is transmitted, (i) the switch 41A may connect the terminal 411 to the terminal 413, and (ii) the switch 43A may connect the terminal 431 to the terminal 432; and assuming a signal in the band A is received and a signal in the band B is transmitted, (i) the switch 41A may connect the terminal 411 to the terminals 413 and 415 and connect the terminal 414 to the terminal 412, (ii) the switch 42A may connect the terminal 421 to the terminal 423 and connect the terminal 424 to the terminal 422, and (iii) the switch 43A may connect the terminal 431 to the terminal 433 and connect the terminal 434 to the terminal 432.

With this configuration, assuming reception of a signal in the band A and transmission of a signal in the band B are performed simultaneously, the filters 31 and 32 are connected in series to the reception path. This makes it possible to improve the attenuation characteristics of the band B in the reception path of the band A and to suppress the degradation of NF of a reception signal in the band A due to simultaneous communication. On the other hand, assuming reception of a signal in the band A is performed solely, the filter 31 is not connected to the reception path. Accordingly, assuming NF is not expected to be degraded due to simultaneous communication, an increase in signal loss due to the use of the two filters 31 and 32 can be prevented.

### Second Embodiment

Next, a second embodiment is described. The present embodiment is mainly different from the first embodiment in the circuit configuration for connecting two filters in series between an antenna connection terminal and a radio frequency output terminal. A communication apparatus 5B and a radio frequency circuit 1B according to the present embodiment are described below with reference to the drawings, focusing on differences from the first embodiment.

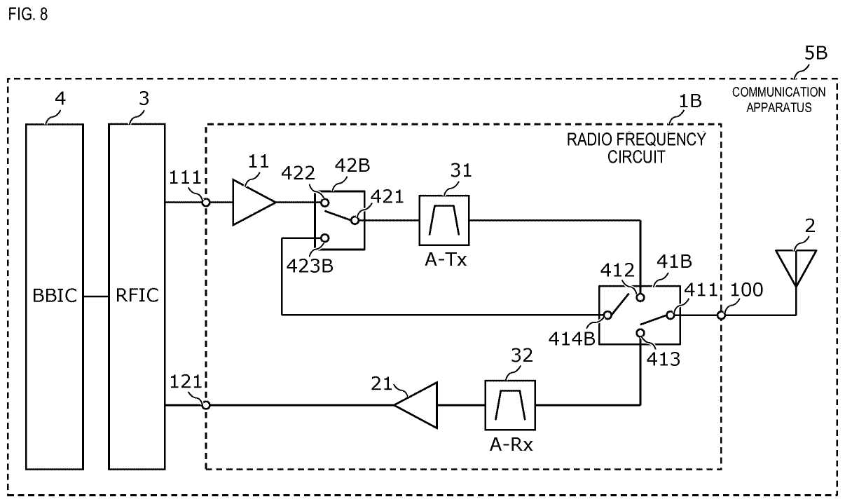

FIG. 8 is a circuit diagram of the communication apparatus 5B according to the present embodiment. Here, FIG. 8 illustrates an exemplary circuit configuration, and the communication apparatus 5B and the radio frequency circuit 1B may be implemented by using any of various types of circuit implementations and circuit technologies. Accordingly, descriptions of the communication apparatus 5B and the radio frequency circuit 1B provided below should not be interpreted restrictively.

The communication apparatus 5B according to the present embodiment is substantially the same as the communication apparatus 5 except that the communication apparatus 5B includes the radio frequency circuit 1B instead of the radio frequency circuit 1. Therefore, descriptions of the communication apparatus 5B are omitted.

### [2.1 Circuit Configuration of Radio Frequency Circuit 1B]

The radio frequency circuit 1B according to the present embodiment includes a power amplifier 11, a low-noise amplifier 21, filters 31 and 32, switches 41B and 42B, an antenna connection terminal 100, a radio frequency input terminal 111, and a radio frequency output terminal 121.

The switch 41B is an example of a first switch and constitutes a part of a switch circuit. The switch 41B includes terminals 411 to 413 and 414B. The terminal 411 is an example of a first terminal and is connected to the antenna connection terminal 100. The terminal 412 is an example of a second terminal and is connected to a first end of the filter 31. The terminal 413 is an example of a third terminal and is connected to a first end of the filter 32. The terminal 414B is an example of a fourth terminal and is connected to the switch 42B.

With this connection configuration, the switch 41B may selectively connect the terminal 411 to the terminals 412 and 413 based on, for example, a control signal from the RFIC 3. In other words, the switch 41B can exclusively connect the terminal 411 to one of the terminals 412 and 413. Also, the switch 41B can connect the terminal 414B to the terminal 413.

The switch 42B is an example of a second switch and constitutes a part of the switch circuit. The switch 42B includes terminals 421, 422, and 423B. The terminal 421 is an example of a fifth terminal and is connected to a second end of the filter 31. The terminal 422 is an example of a sixth terminal and is connected to the output end of the power amplifier 11. The terminal 423B is an example of a seventh terminal and is connected to the terminal 414B of the switch 41B.

With this connection configuration, the switch 42B can selectively connect the terminal 421 to the terminals 422 and 423B based on, for example, a control signal from the RFIC 3. In other words, the switch 42B can exclusively connect the terminal 421 to one of the terminals 422 and 423B.

The switch circuit including the switches 41B and 42B may be implemented in one semiconductor integrated circuit or in multiple integrated circuits. The switch circuit may be implemented by any appropriate implementation method.

### [2.2 Modes of Radio Frequency Circuit 1B]

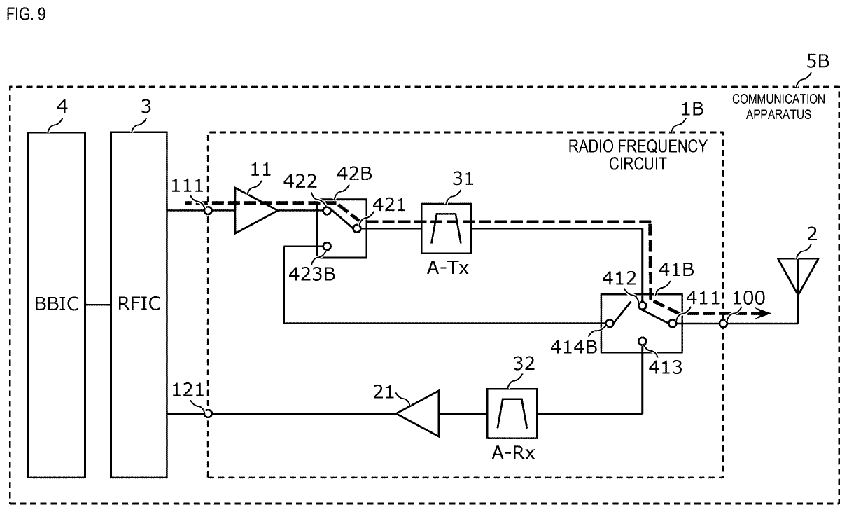

Next, multiple modes of the radio frequency circuit 1B are described with reference to FIGS. 9 to 11.

First, a first mode of the radio frequency circuit 1B is described with reference to FIG. 9. FIG. 9 illustrates a path of a radio frequency signal in the first mode of the radio frequency circuit 1B according to the present embodiment. In FIG. 9, a dotted arrow represents a transmission path of a radio frequency signal.

As illustrated in FIG. 9, in the first mode, the filter 31 is connected, but the filter 32 is not connected, between the antenna connection terminal 100 and the radio frequency input terminal 111. Specifically, in the switch 41B, the terminal 411 is connected to the terminal 412 but is not connected to the terminal 413. Also, the terminal 414B is not connected to the terminal 413. In the switch 42B, the terminal 421 is connected to the terminal 422 but is not connected to the terminal 423.

In this mode, a transmission signal in the band A received from the RFIC 3 via the radio frequency input terminal 111 is transmitted to the antenna connection terminal 100 via the power amplifier 11, the switch 42B, the filter 31, and the switch 41B.

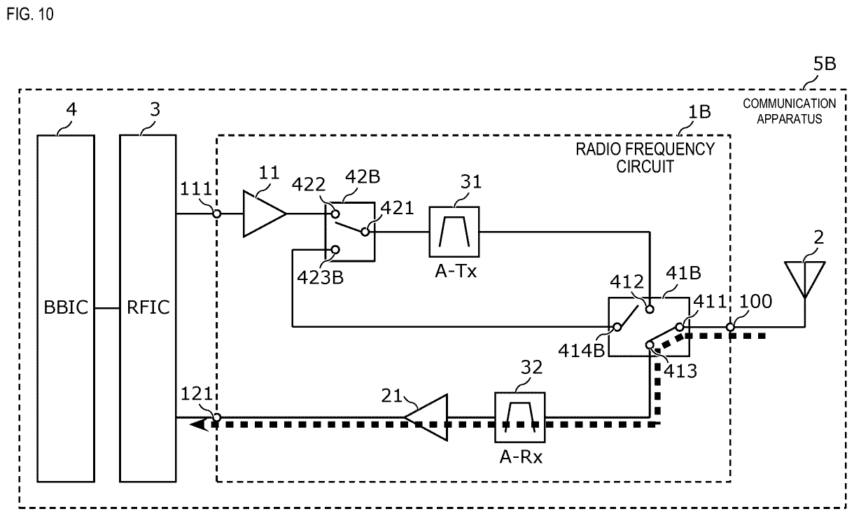

Next, a second mode of the radio frequency circuit 1B is described with reference to FIG. 10. FIG. 10 illustrates a path of a radio frequency signal in the second mode of the radio frequency circuit 1B according to the present embodiment. In FIG. 10, a dotted arrow represents a reception path of a radio frequency signal.

As illustrated in FIG. 10, in the second mode, the filter 32 is connected, but the filter 31 is not connected, between the antenna connection terminal 100 and the radio frequency output terminal 121. Specifically, in the switch 41B, the terminal 411 is connected to the terminal 413 but is not connected to the terminal 412. Also, the terminal 414B is not connected to the terminal 413. In the switch 42B, none of the terminals is connected to any other terminal.

In this mode, a reception signal in the band A received from the antenna 2 via the antenna connection terminal 100 is transmitted to the radio frequency output terminal 121 via the switch 41B, the filter 32, and the low-noise amplifier 21.

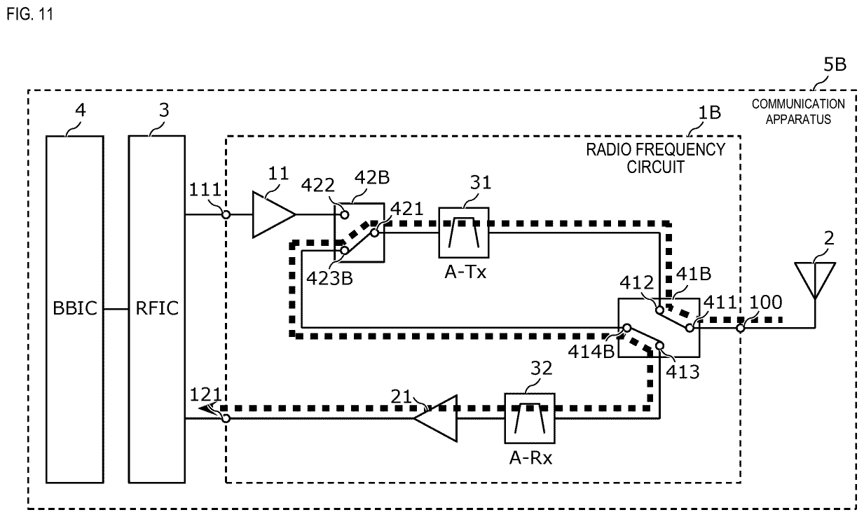

Finally, a third mode of the radio frequency circuit 1B is described with reference to FIG. 11. FIG. 11 illustrates a path of a radio frequency signal in the third mode of the radio frequency circuit 1B according to the present embodiment. In FIG. 11, a dotted arrow represents a reception path of a radio frequency signal.

As illustrated in FIG. 11, in the third mode, the filters 31 and 32 are connected in series between the antenna connection terminal 100 and the radio frequency output terminal 121. Specifically, in the switch 41B, the terminal 411 is connected to the terminal 412 but is not connected to the terminal 413. Also, the terminal 414B is connected to the terminal 413. In the switch 42B, the terminal 421 is connected to the terminal 423B but is not connected to the terminal 422.

In this mode, a reception signal in the band A received from the antenna 2 via the antenna connection terminal 100 is transmitted to the radio frequency output terminal 121 via the switch 41B, the filter 31, the switch 42B, the switch 41B, the filter 32, and the low-noise amplifier 21.

The second mode and the third mode for receiving signals in the band A are switched by the RFIC 3 based on, for example, a reception signal level in the band A. The second mode and the third mode may also be switched based on factors other than the reception signal level in the band A. For example, the second mode and the third mode may be switched based on whether the band A is used simultaneously with another band for communication. Also, the second mode and the third mode may be switched based on the power class or average output power of the other band.

### [2.3 Effects]

As described above, the radio frequency circuit 1B according to the present embodiment includes the filter 31 with a pass band including at least a part of the band A for TDD, the filter 32 with a pass band including at least a part of the band A, and the switch circuit that has (i) the first mode in which the filter 31 is connected between the antenna connection terminal 100 and the radio frequency input terminal 111, (ii) the second mode in which the filter 32 is connected between the antenna connection terminal 100 and the radio frequency output terminal 121, and (iii) the third mode in which the filters 31 and 32 are connected in series between the antenna connection terminal 100 and the radio frequency input terminal 111 or between the antenna connection terminal 100 and the radio frequency output terminal 121.

With this configuration, a signal in the band A for TDD can be received in the third mode in which the filter 31 for transmission and the filter 32 for reception are connected in series to the reception path. Compared with a case in which a signal in the band A is received in the second mode where the filter 31 is not connected to the reception path, this configuration makes it possible to improve the attenuation characteristics outside of the band A. Also, with the above configuration, it is possible to receive a signal in the band A in the second mode where the filter 31 is not connected to the reception path. This in turn makes it possible to prevent an increase in signal loss due to the use of the two filters 31 and 32. Furthermore, the above configuration makes it possible to share the filter 31 in the first mode (transmission) and the third mode (reception) and thereby makes it possible to prevent an increase in the number of filters.

Also, for example, in the radio frequency circuit 1B according to the present embodiment, the switch circuit may include the switch 41B and the switch 42B; the switch 41B may include the terminal 411 connected to the antenna connection terminal 100, the terminal 412 connected to the first end of the filter 31, the terminal 413 connected to the first end of the filter 32, and the terminal 414B connected to the switch 42B; the switch 42B may include the terminal 421 connected to the second end of the filter 31, the terminal 422 connected to the radio frequency input terminal 111, and the terminal 423B connected to the terminal 414B of the switch 41B; and the radio frequency output terminal 121 may be connected to the second end of the filter 32.

With this configuration, it is possible to switch between the first mode, the second mode, and the third mode by using the two switches 41B and 42B. Particularly, this configuration makes it possible to eliminate a path connecting a terminal of a switch connected to a transmission path to a terminal of a switch connected to a reception path (e.g., the path connecting the terminal 423 of the switch 42 to the terminal 433 of the switch 43 in FIG. 1) and thereby makes it possible to suppress the degradation of isolation between the transmission path and the reception path.

Also, for example, in the radio frequency circuit 1B according to the present embodiment, the switch 41B may be capable of connecting the terminal 411 to the terminal 412 and the terminal 413 and connecting the terminal 414B to the terminal 413; and the switch 42B may be capable of connecting the terminal 421 to the terminals 422 and 423B.

With this configuration, it is possible to switch between the first mode, the second mode, and the third mode by using the two switches 41B and 42B. Particularly, the switch 41B can connect the terminal 414B to the terminal 413, and the switch 42B can connect the terminal 421 to the terminal 423B. This configuration makes it possible to enable a reception signal in the band A, which has passed through the filter 31, to pass through the filter 32 without using a path that connects a terminal of a switch connected to the transmission path to a terminal of a switch connected to the reception path and thereby makes it possible to suppress the degradation of isolation between the transmission path and the reception path.

Also, for example, in the radio frequency circuit 1B according to the present embodiment, in the first mode, the switch 41B may connect the terminal 411 to the terminal 412, and the switch 42B may connect the terminal 421 to the terminal 422; in the second mode, the switch 41B may connect the terminal 411 to the terminal 413; and in the third mode, the switch 41B may connect the terminal 411 to the terminal 412 and connect the terminal 414B to the terminal 413, and the switch 42B may connect the terminal 421 to the terminal 423B.

With this configuration, in the third mode, the switch 41B is controlled such that the terminal 411 is connected to the terminal 412 and the terminal 414B is connected to the terminal 413, and the switch 42B is controlled such that the terminal 421 is connected to the terminal 423B. This configuration makes it possible to enable a reception signal in the band A, which has passed through the filter 31, to pass through the filter 32 without using a path that connects a terminal of a switch connected to the transmission path to a terminal of a switch connected to the reception path and thereby makes it possible to suppress the degradation of isolation between the transmission path and the reception path.

Also, for example, in the radio frequency circuit 1B according to the present embodiment, (i) in the first mode, the switch circuit does not necessarily connect the filter 32 between the antenna connection terminal 100 and the radio frequency input terminal 111, and (ii) in the second mode, the switch circuit does not necessarily connect the filter 31 between the antenna connection terminal 100 and the radio frequency output terminal 121.

With this configuration, signal loss can be reduced more in the second mode than in the third mode.

In a different point of view, the radio frequency circuit 1B according to the present embodiment includes the filter 31 with a pass band including at least a part of the band A for time division duplex, the filter 32 with a pass band including at least a part of the band A, and the switches 41B and 42B. The switch 41B includes the terminal 411 connected to the antenna connection terminal 100, the terminal 412 connected to the first end of the filter 31, the terminal 413 connected to the first end of the filter 32, and the terminal 414B connected to the switch 42B. The switch 42B includes the terminal 421 connected to the second end of the filter 31, the terminal 422 connected to the radio frequency input terminal 111, and the terminal 423B connected to the terminal 414B of the switch 41B. The second end of the filter 32 is connected to the radio frequency output terminal 121.

With this configuration, by using the two switches 41B and 42B, (i) the filter 31 can be connected between the antenna connection terminal 100 and the radio frequency input terminal 111, (ii) the filter 32 can be connected, without connecting the filter 31, between the antenna connection terminal 100 and the radio frequency output terminal 121, and (iii) the filters 31 and 32 can be connected in series between the antenna connection terminal 100 and the radio frequency output terminal 121. Particularly, because it is not necessary to connect any terminal of the switch 42B to a terminal of a switch connected to the reception path, the degradation of isolation between the transmission path and the reception path can be suppressed.

### Variation of Second Embodiment

Next, a variation of the second embodiment is described. A radio frequency circuit 1C according to the present variation mainly differs from the radio frequency circuit 1B according to the second embodiment in that the radio frequency circuit 1C supports, in addition to the band A, the band B that can be used simultaneously with the band A for communication. A communication apparatus 5C and the radio frequency circuit 1C according to the present variation are described below with reference to the drawings, focusing on differences from the communication apparatuses 5, 5A, and 5B and the radio frequency circuits 1, 1A, and 1B.

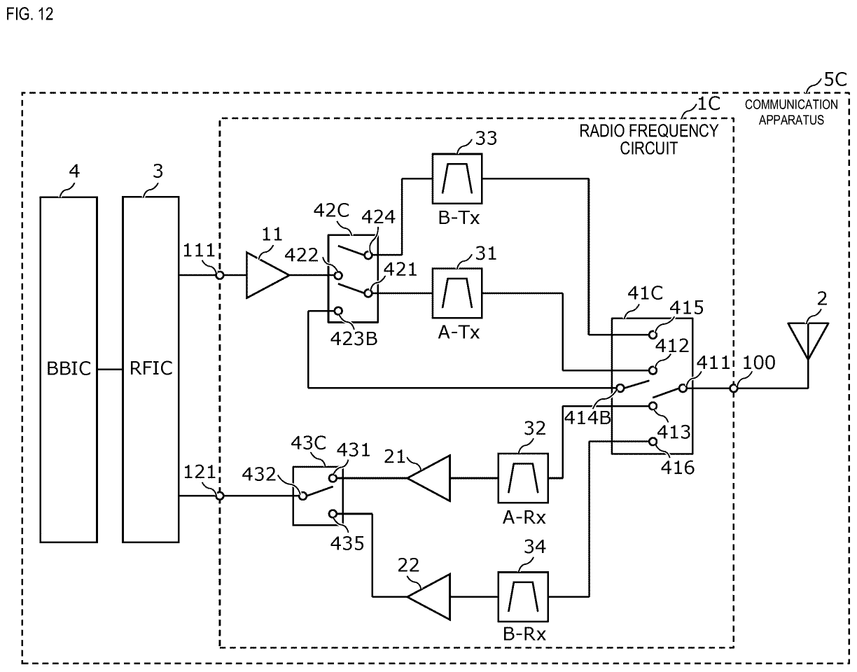

FIG. 12 is a circuit diagram of the communication apparatus 5C according to the present variation. Here, FIG. 12 illustrates an exemplary circuit configuration, and the communication apparatus 5C and the radio frequency circuit 1C may be implemented by using any of various types of circuit implementations and circuit technologies. Accordingly, descriptions of the communication apparatus 5C and the radio frequency circuit 1C provided below should not be interpreted restrictively.

The communication apparatus 5C according to the present variation differs from the communication apparatus 5 only in that the communication apparatus 5C includes the radio frequency circuit 1C instead of the radio frequency circuit 1. Therefore, descriptions of the communication apparatus 5C are omitted.

### [2.4 Circuit Configuration of Radio Frequency Circuit 1C]

The radio frequency circuit 1C according to the present variation includes a power amplifier 11, low-noise amplifiers 21 and 22, filters 31 to 34, switches 41C to 43C, an antenna connection terminal 100, a radio frequency input terminal 111, and a radio frequency output terminal 121.

The switch 41C is an example of a first switch and constitutes a part of a switch circuit. The switch 41C includes terminals 411 to 413, 414B, 415, and 416. The terminal 412 is an example of a second terminal and is connected to a first end of the filter 31. The terminal 413 is an example of a third terminal and is connected to a first end of the filter 32. The terminal 414B is an example of a fourth terminal and is connected to the switch 42C. The terminal 415 is an example of an eighth terminal and is connected to a first end of the filter 33. The terminal 416 is connected to a first end of the filter 34.

With this connection configuration, the switch 41C can selectively connect the terminal 411 to the terminals 412 and 413 and selectively connect the terminal 411 to the terminals 415 and 416 based on, for example, a control signal from the RFIC 3. Also, the switch 41C can connect the terminal 414B to the terminal 413.

The switch 42C is an example of a second switch and constitutes a part of the switch circuit. The switch 42C includes terminals 421, 422, 423B, and 424. The terminal 421 is an example of a fifth terminal and is connected to a second end of the filter 31. The terminal 422 is an example of a sixth terminal and is connected to the output end of the power amplifier 11. The terminal 423B is an example of a seventh terminal and is connected to the terminal 414B of the switch 41C. The terminal 424 is an example of a ninth terminal and is connected to a second end of the filter 33.

With this connection configuration, the switch 42C can selectively connect the terminal 422 to the terminals 421 and 424 based on, for example, a control signal from the RFIC 3. Also, the switch 42C can connect the terminal 421 to the terminal 423B.

The switch 43C includes terminals 431, 432, and 435. The terminal 431 is connected to a second end of the filter 32 via the low-noise amplifier 21. The terminal 432 is connected to the radio frequency output terminal 121. The terminal 435 is connected to a second end of the filter 34 via the low-noise amplifier 22.

With this connection configuration, the switch 43C can selectively connect the terminal 432 to the terminals 431 and 435 based on, for example, a control signal from the RFIC 3.

The low-noise amplifier 22, the filter 34, and the switch 43C are not necessarily included in the radio frequency circuit 1C. In this case, similarly to FIG. 8, the output end of the low-noise amplifier 21 may be connected to the radio frequency output terminal 121.

Also, the low-noise amplifier 21 may be connected between the switch 43C and the radio frequency output terminal 121. Specifically, the input end of the low-noise amplifier 21 may be connected to the terminal 432 of the switch 43C, and the output end of the low-noise amplifier 21 may be connected to the radio frequency output terminal 121. In this case, the low-noise amplifier 22 is not necessarily included in the radio frequency circuit 1C.

The switch circuit including the switches 41C and 42C may be implemented in one semiconductor integrated circuit or in multiple semiconductor integrated circuits. The switch circuit may be implemented by any appropriate implementation method.

### [2.5 Modes of Radio Frequency Circuit 1C]

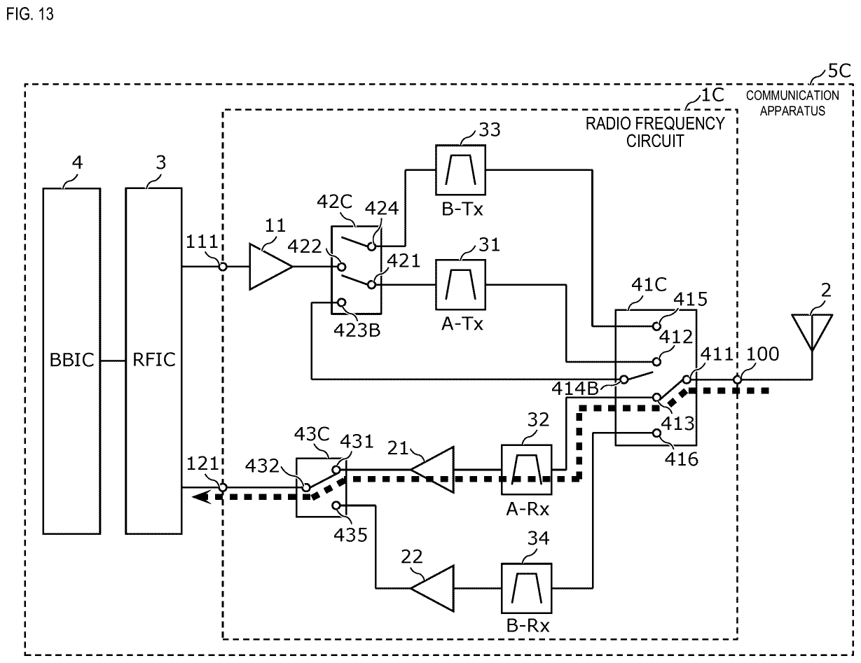

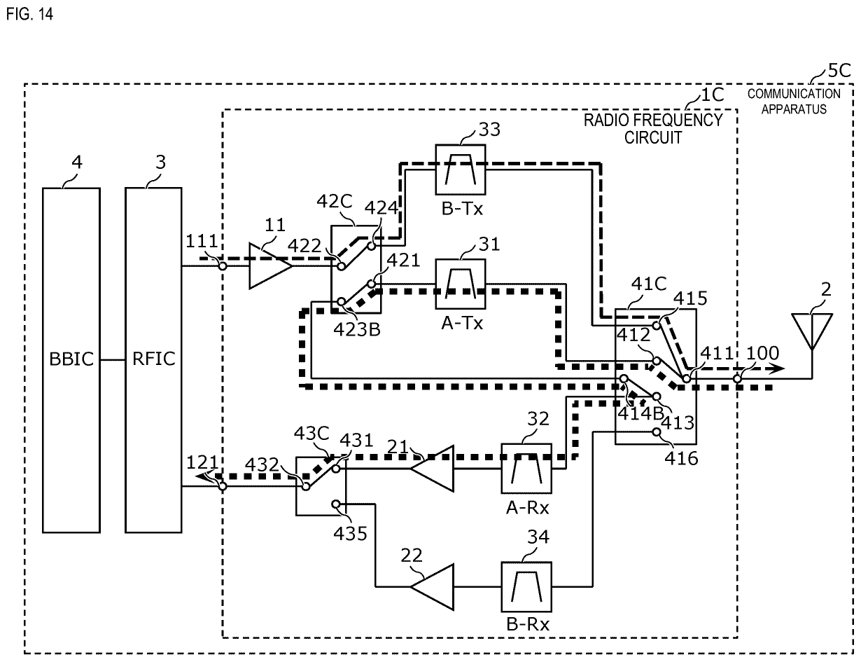

Next, a second mode and a third mode of the radio frequency circuit 1C are described with reference to FIGS. 13 and 14. FIG. 13 illustrates a path of a radio frequency signal in the second mode of the radio frequency circuit 1C according to the present variation. FIG. 14 illustrates a path of a radio frequency signal in the third mode of the radio frequency circuit 1C according to the present variation. In FIGS. 13 and 14, each dotted arrow represents a transmission path or a reception path of a radio frequency signal.

As illustrated in FIG. 13, the radio frequency circuit 1C is controlled in the second mode assuming a signal in the band A is received and no signal in the band B is transmitted. In the second mode, the filter 32 is connected, but the filter 31 is not connected, between the antenna connection terminal 100 and the radio frequency output terminal 121. Specifically, in the switch 41C, the terminal 411 is connected to the terminal 413 but is not connected to the terminals 412, 415, and 416. Also, the terminal 414B is not connected to the terminal 413. In the switch 43C, the terminal 432 is connected to the terminal 431 but is not connected to the terminal 435.

In this mode, a reception signal in the band A received from the antenna 2 via the antenna connection terminal 100 is transmitted to the radio frequency output terminal 121 via the switch 41C, the filter 32, the low-noise amplifier 21, and the switch 43C.

As illustrated in FIG. 14, the radio frequency circuit 1C is controlled in the third mode assuming a signal in the band A is received and a signal in the band B is transmitted. In the third mode, the filters 31 and 32 are connected in series between the antenna connection terminal 100 and the radio frequency output terminal 121. Also, the filter 33 is connected between the antenna connection terminal 100 and the radio frequency input terminal 111.

Specifically, in the switch 41C, the terminal 411 is connected to the terminals 412 and 415 but is not connected to the terminals 413 and 416. Additionally, the terminal 414B is connected to the terminal 413. In the switch 42C, the terminal 421 is connected to the terminal 423B but is not connected to the terminal 422. Also, the terminal 424 is connected to the terminal 422. In the switch 43C, the terminal 432 is connected to the terminal 431 but is not connected to the terminal 435.

In this mode, a reception signal in the band A received from the antenna 2 via the antenna connection terminal 100 is transmitted to the radio frequency output terminal 121 via the switch 41C, the filter 31, the switches 42C and 41C, the filter 32, the low-noise amplifier 21, and the switch 43C. Also, a transmission signal in the band B received from the RFIC 3 via the radio frequency input terminal 111 is transmitted to the antenna connection terminal 100 via the power amplifier 11, the switch 42C, the filter 33, and the switch 41C.

Thus, in the present variation, the second mode (FIG. 13) is used assuming a signal in the band A is received and no signal in the band B is transmitted. On the other hand, the third mode (FIG. 14) is used assuming a signal in the band A is received and a signal in the band B is transmitted. That is, in the radio frequency circuit 1C, (i) the second mode is used assuming reception in the band A is performed solely, and (ii) the third mode is used assuming reception in the band A and transmission in the band B are performed simultaneously.

In the radio frequency circuit 1C, similarly to FIG. 9, the first mode may also be used to perform only transmission in the band A. Also, a mode for performing only transmission in the band B and/or a mode for performing only reception in the band B may be used. Furthermore, a mode for simultaneously performing transmission in the band A and reception in the band B may be used.

### [2.6 Effects]

Also, for example, the radio frequency circuit 1C according to the present variation further includes the filter 33 with a pass band including at least a part of the band B that can be used simultaneously with the band A for communication, the switch 41C further includes the terminal 415 that is connected to the first end of the filter 33, and the switch 42C further includes the terminal 424 that is connected to the second end of the filter 33.

With this configuration, the radio frequency circuit 1C can support, in addition to the band A, the band B that can be used simultaneously with the band A for communication.

Also, for example, in the radio frequency circuit 1C according to the present variation, assuming a signal in the band A is received and no signal in the band B is transmitted, the switch 41C may connect the terminal 411 to the terminal 413; and assuming a signal in the band A is received and a signal in the band B is transmitted, (i) the switch 41C may connect the terminal 411 to the terminals 412 and 415 and connect the terminal 414B to the terminal 413, and (ii) the switch 42C may connect the terminal 421 to the terminal 423B and connect the terminal 424 to the terminal 422.

With this configuration, assuming reception of a signal in the band A and transmission of a signal in the band B are performed simultaneously, the filters 31 and 32 are connected in series to the reception path. This makes it possible to improve the attenuation characteristics of the band B in the reception path of the band A and to suppress the degradation of NF of a reception signal in the band A due to simultaneous communication. On the other hand, assuming reception of a signal in the band A is performed solely, the filter 31 is not connected to the reception path. Accordingly, assuming NF is not expected to be degraded due to simultaneous communication, an increase in signal loss due to the use of the two filters 31 and 32 can be prevented.

### Third Embodiment

Next, a third embodiment is described. The present embodiment differs mainly from the first and second embodiments in that two filters are connected in series between an antenna connection terminal and a radio frequency input terminal. A communication apparatus 5D and a radio frequency circuit 1D according to the present embodiment are described below with reference to the drawings, focusing on differences from the first and second embodiments.

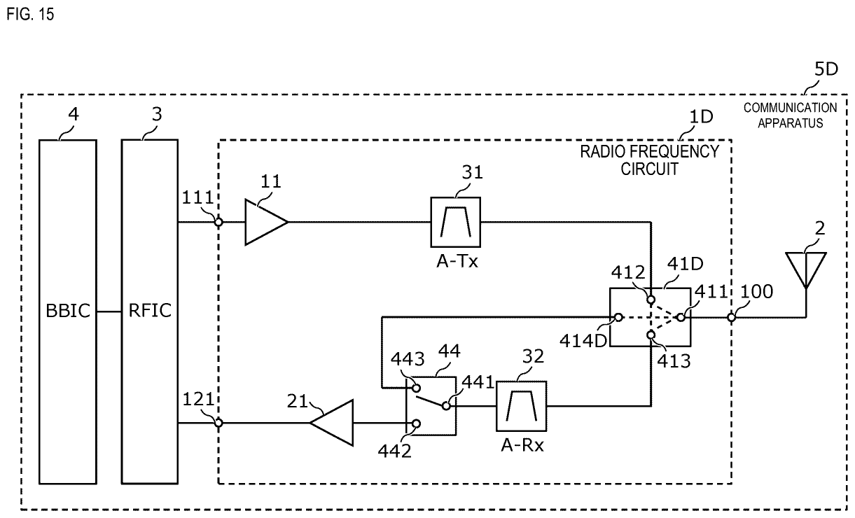

FIG. 15 is a circuit diagram of the communication apparatus 5D according to the present embodiment. Here, FIG. 15 illustrates an exemplary circuit configuration, and the communication apparatus 5D and the radio frequency circuit 1D may be implemented by using any of various types of circuit implementations and circuit technologies. Accordingly, descriptions of the communication apparatus 5D and the radio frequency circuit 1D provided below should not be interpreted restrictively.

The communication apparatus 5D according to the present embodiment is substantially the same as the communication apparatus 5 except that the communication apparatus 5D includes the radio frequency circuit 1D instead of the radio frequency circuit 1. Therefore, descriptions of the communication apparatus 5D are omitted.

### [3.1 Circuit Configuration of Radio Frequency Circuit 1D]

The radio frequency circuit 1D according to the present embodiment includes a power amplifier 11, a low-noise amplifier 21, filters 31 and 32, switches 41D and 44, an antenna connection terminal 100, a radio frequency input terminal 111, and a radio frequency output terminal 121.

The switch 41D is an example of a first switch and constitutes a part of a switch circuit. The switch 41D includes terminals 411 to 413 and 414D. The terminal 411 is an example of a first terminal and is connected to the antenna connection terminal 100. The terminal 412 is an example of a second terminal and is connected to a first end of the filter 31. The terminal 413 is an example of a third terminal and is connected to a first end of the filter 32. The terminal 414D is an example of a fourth terminal and is connected to the switch 44.

With this connection configuration, the switch 41D can selectively connect the terminal 411 to the terminals 412, 413, and 414D based on, for example, a control signal from the RFIC 3. In other words, the switch 41D can exclusively connect the terminal 411 to one of the terminals 412, 413, and 414D. Also, the switch 41D can connect the terminal 412 to the terminal 413.

The switch 44 is an example of a second switch and constitutes a part of the switch circuit. The switch 44 includes terminals 441 to 443. The terminal 441 is an example of a fifth terminal and is connected to a second end of the filter 32. The terminal 442 is an example of a sixth terminal and is connected to the radio frequency output terminal 121 via the low-noise amplifier 21. The terminal 443 is an example of a seventh terminal and is connected to the terminal 414D of the switch 41D.

With this connection configuration, the switch 44 can selectively connect the terminal 441 to the terminals 442 and 443 based on, for example, a control signal from the RFIC 3. In other words, the switch 44 can exclusively connect the terminal 441 to one of the terminals 442 and 443.

### [3.2 Modes of Radio Frequency Circuit 1D]

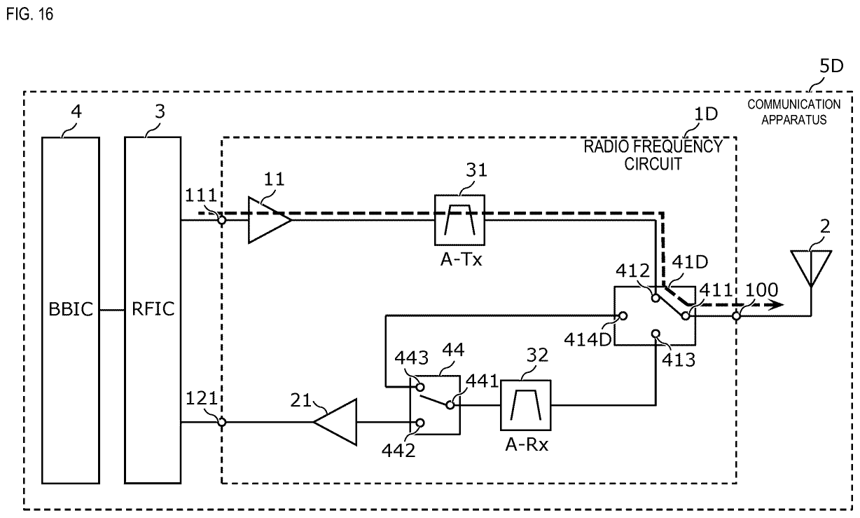

Next, multiple modes of the radio frequency circuit 1D are described with reference to FIGS. 16 to 18.

First, a first mode of the radio frequency circuit 1D is described with reference to FIG. 16. FIG. 16 illustrates a path of a radio frequency signal in the first mode of the radio frequency circuit 1D according to the present embodiment. In FIG. 16, a dotted arrow represents a transmission path of a radio frequency signal.

As illustrated in FIG. 16, in the first mode, the filter 31 is connected, but the filter 32 is not connected, between the antenna connection terminal 100 and the radio frequency input terminal 111. Specifically, in the switch 41D, the terminal 411 is connected to the terminal 412 but is not connected to the terminals 413 and 414D. Also, the terminal 412 is not connected to the terminal 413. In the switch 44, no terminal is connected to any other terminal.

In this mode, a transmission signal in the band A received from the RFIC 3 via the radio frequency input terminal 111 is transmitted to the antenna connection terminal 100 via the power amplifier 11, the filter 31, and the switch 41D.

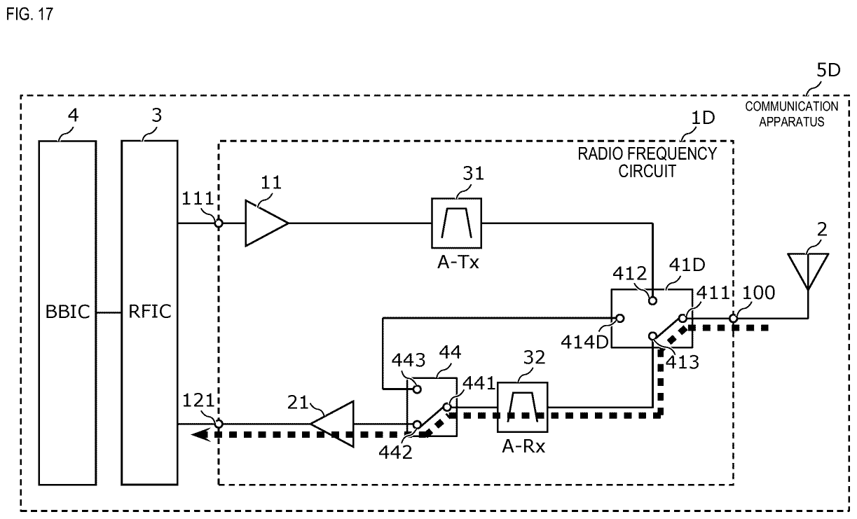

Next, a second mode of the radio frequency circuit 1D is described with reference to FIG. 17. FIG. 17 illustrates a path of a radio frequency signal in the second mode of the radio frequency circuit 1D according to the present embodiment. In FIG. 17, a dotted arrow represents a reception path of a radio frequency signal.

As illustrated in FIG. 17, in the second mode, the filter 32 is connected, but the filter 31 is not connected, between the antenna connection terminal 100 and the radio frequency output terminal 121. Specifically, in the switch 41D, the terminal 411 is connected to the terminal 413 but is not connected to the terminals 412 and 414D. Also, the terminal 412 is not connected to the terminal 413. In the switch 44, the terminal 441 is connected to the terminal 442 but is not connected to the terminal 443.

In this mode, a reception signal in the band A received from the antenna 2 via the antenna connection terminal 100 is transmitted to the radio frequency output terminal 121 via the switch 41D, the filter 32, the switch 44, and the low-noise amplifier 21.

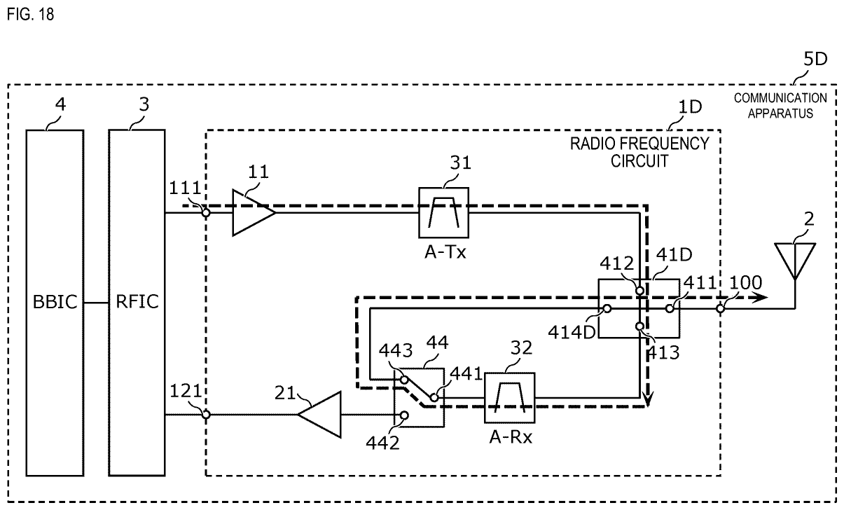

Finally, a third mode of the radio frequency circuit 1D is described with reference to FIG. 18. FIG. 18 illustrates a path of a radio frequency signal in the third mode of the radio frequency circuit 1D according to the present embodiment. In FIG. 18, a dotted arrow represents a transmission path of a radio frequency signal.

As illustrated in FIG. 18, in the third mode, the filters 31 and 32 are connected in series between the antenna connection terminal 100 and the radio frequency input terminal 111. Specifically, in the switch 41D, the terminal 411 is connected to the terminal 414D but is not connected to the terminals 412 and 413. Also, the terminal 412 is connected to the terminal 413. In the switch 44, the terminal 441 is connected to the terminal 443 but is not connected to the terminal 442.

In this mode, a transmission signal in the band A received from the RFIC 3 via the radio frequency input terminal 111 is transmitted to the antenna connection terminal 100 via the power amplifier 11, the filter 31, the switch 41D, the filter 32, the switch 44, and the switch 41D.

The first mode and the third mode for transmitting signals in the band A are switched by the RFIC 3 based on, for example, the power class of the band A. The first mode and the third mode may also be switched based on factors other than the power class of the band A. For example, the first mode and the third mode may be switched based on whether the band A is used simultaneously with another band for communication. Also, the first mode and the third mode may be switched based on the reception signal level of the other band.

### [3.3 Effects]

As described above, the radio frequency circuit 1D according to the present embodiment includes the filter 31 with a pass band including at least a part of the band A for TDD, the filter 32 with a pass band including at least a part of the band A, and the switch circuit that has (i) the first mode in which the filter 31 is connected between the antenna connection terminal 100 and the radio frequency input terminal 111, (ii) the second mode in which the filter 32 is connected between the antenna connection terminal 100 and the radio frequency output terminal 121, and (iii) the third mode in which the filters 31 and 32 are connected in series between the antenna connection terminal 100 and the radio frequency input terminal 111 or between the antenna connection terminal 100 and the radio frequency output terminal 121.

With this configuration, a signal in the band A for TDD can be transmitted in the third mode in which the filter 31 for transmission and the filter 32 for reception are connected in series to the transmission path. Accordingly, compared with a case in which a signal in the band A is transmitted in the first mode where the filter 32 is not connected to the transmission path, this configuration makes it possible to improve the attenuation characteristics outside of the band A. Also, it is possible to transmit a signal in the band A in the second mode where the filter 32 is not connected to the transmission path to prevent an increase in signal loss due to the use of the two filters 31 and 32. Furthermore, the above configuration makes it possible to share the filter 32 in the second mode (reception) and the third mode (transmission) and thereby makes it possible to prevent an increase in the number of filters.

Also, for example, in the radio frequency circuit 1D according to the present embodiment, the switch circuit may include the switches 41D and 44; the switch 41D may include the terminal 411 connected to the antenna connection terminal 100, the terminal 412 connected to the first end of the filter 31, the terminal 413 connected to the first end of the filter 32, and the terminal 414D connected to the switch 44; the switch 44 may include the terminal 441 connected to the second end of the filter 32, the terminal 442 connected to the radio frequency output terminal 121, and the terminal 443 connected to the terminal 414D of the switch 41D; and the second end of the filter 31 may be connected to the radio frequency input terminal 111.

With this configuration, the first mode, the second mode, and the third mode can be switched by using the two switches 41D and 44.

Also, for example, in the radio frequency circuit 1D according to the present embodiment, the switch 41D may be capable of connecting the terminal 411 to the terminals 412, 413, and 414D and connecting the terminal 412 to the terminal 413; and the switch 44 may be capable of connecting the terminal 441 to the terminals 442 and 443.

With this configuration, the first mode, the second mode, and the third mode can be switched by using the two switches 41D and 44.

Also, for example, in the radio frequency circuit 1D according to the present embodiment, in the first mode, the switch 41D may connect the terminal 411 to the terminal 412; in the second mode, the switch 41D may connect the terminal 411 to the terminal 413, and the switch 44 may connect the terminal 441 to the terminal 442; and in the third mode, the switch 41D may connect the terminal 411 to the terminal 414D and connect the terminal 412 to the terminal 413, and the switch 44 may connect the terminal 441 to the terminal 443.

With this configuration, the third mode can be achieved by controlling the switch 41D to connect the terminal 414D to the terminal 411 and controlling the switch 44 to connect the terminal 441 to the terminal 443.

Also, for example, in the radio frequency circuit 1D according to the present embodiment, (i) in the first mode, the switch circuit does not necessarily connect the filter 32 between the antenna connection terminal 100 and the radio frequency input terminal 111, and (ii) in the second mode, the switch circuit does not necessarily connect the filter 31 between the antenna connection terminal 100 and the radio frequency output terminal 121.

With this configuration, signal loss can be reduced more in the first mode than in the third mode.

### Variation of Third Embodiment

Next, a variation of the third embodiment is described. A radio frequency circuit 1E according to the present variation mainly differs from the radio frequency circuit 1D according to the third embodiment in that the radio frequency circuit 1E supports, in addition to the band A, a band C that can be used simultaneously with the band A for communication. A communication apparatus 5E and the radio frequency circuit 1E according to the present variation are described below with reference to the drawings, focusing on differences from the communication apparatuses 5 and 5A to 5D and the radio frequency circuits 1 and 1A to 1D.

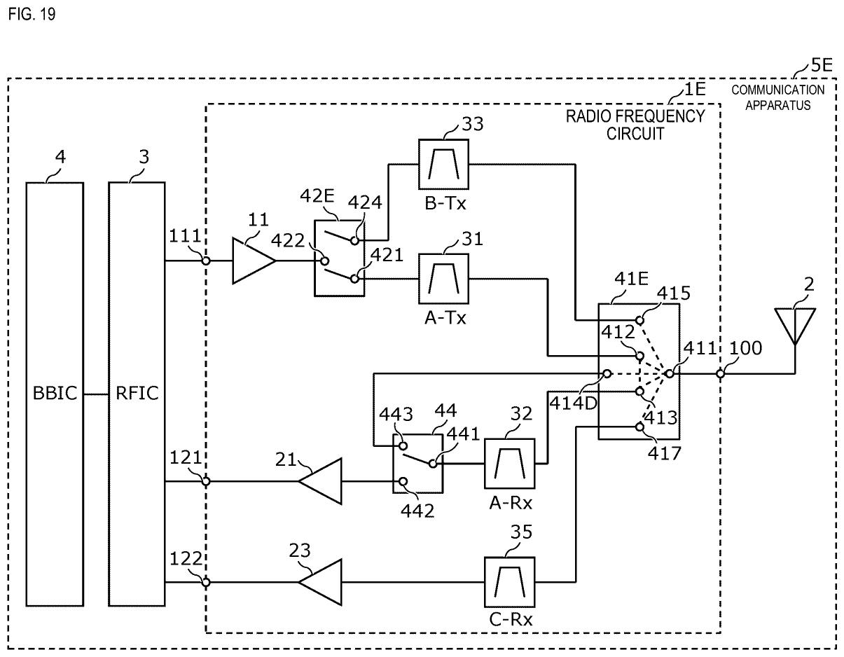

FIG. 19 is a circuit diagram of the communication apparatus 5E according to the present variation. Here, FIG. 19 illustrates an exemplary circuit configuration, and the communication apparatus 5E and the radio frequency circuit 1E may be implemented by using any of various types of circuit implementations and circuit technologies. Accordingly, descriptions of the communication apparatus 5E and the radio frequency circuit 1E provided below should not be interpreted restrictively.

The communication apparatus 5E according to the present variation differs from the communication apparatus 5 only in that the communication apparatus 5E includes the radio frequency circuit 1E instead of the radio frequency circuit 1. Therefore, descriptions of the communication apparatus 5E are omitted.

### [3.4 Circuit Configuration of Radio Frequency Circuit 1E]

The radio frequency circuit 1E according to the present variation includes a power amplifier 11, low-noise amplifiers 21 and 23, filters 31 to 33 and 35, switches 41E, 42E, and 44, an antenna connection terminal 100, a radio frequency input terminal 111, and radio frequency output terminals 121 and 122.

The radio frequency output terminal 122 is an external connection terminal of the radio frequency circuit 1E and supplies reception signals to the outside of the radio frequency circuit 1E. The radio frequency output terminal 122 is connected to the RFIC 3 outside of the radio frequency circuit 1E and to the output end of the low-noise amplifier 23 inside of the radio frequency circuit 1E.

The low-noise amplifier 23 is connected between the antenna connection terminal 100 and the radio frequency output terminal 122. Specifically, the input end of the low-noise amplifier 23 is connected to the antenna connection terminal 100 via the filter 35 and the switch 41E. The output end of the low-noise amplifier 23 is connected to the radio frequency output terminal 122. With this connection configuration, the low-noise amplifier 23 can amplify a reception signal in the band C received from the antenna 2 via the antenna connection terminal 100 based on power supplied from a power source (not shown). The low-noise amplifier 23 is not necessarily included in the radio frequency circuit 1E.

The filter 35 (C-Rx) is an example of a fourth filter with a pass band including a reception band in the band C. The filter 35 is connected between the antenna connection terminal 100 and the radio frequency output terminal 122. Specifically, a first end of the filter 35 is connected to the antenna connection terminal 100 via the switch 41E. A second end of the filter 35 is connected to the radio frequency output terminal 122 via the low-noise amplifier 23.

The band C is an example of a third band that is a frequency band for a communication system constructed using RAT. The band C is a frequency band that can be used simultaneously with the band A for communication and is predefined by, for example, a standardization organization. As a non-limiting example, Band 3 for LTE or n3 for 5G NR may be used as the band C.

The switch 41E is an example of a first switch and constitutes a part of a switch circuit. The switch 41E includes terminals 411 to 413, 414D, 415, and 417. The terminal 411 is an example of a first terminal and is connected to the antenna connection terminal 100. The terminal 412 is an example of a second terminal and is connected to a first end of the filter 31. The terminal 413 is an example of a third terminal and is connected to a first end of the filter 32. The terminal 414D is an example of a fourth terminal and is connected to the switch 44. The terminal 417 is an example of an eighth terminal and is connected to a first end of the filter 35.

With this connection configuration, the switch 41E can selectively connect the terminal 411 to the terminals 412, 413, and 414D and connect the terminal 411 to the terminals 415 and 417 based on, for example, a control signal from the RFIC 3. Also, the switch 41E can connect the terminal 412 to the terminal 413.

The switch 42E includes terminals 421, 422, and 424. The terminal 421 is connected to a second end of the filter 31. The terminal 422 is connected to the radio frequency input terminal 111 via the power amplifier 11. The terminal 424 is connected to a second end of the filter 33.

With this connection configuration, the switch 42E can selectively connect the terminal 422 to the terminals 421 and 424 based on, for example, a control signal from the RFIC 3.

The switch 44 is an example of a second switch and constitutes a part of the switch circuit. The switch 44 includes terminals 441 to 443. The terminal 441 is an example of a fifth terminal and is connected to a second end of the filter 32. The terminal 442 is an example of a sixth terminal and is connected to the radio frequency output terminal 121 via the low-noise amplifier 21. The terminal 443 is an example of a seventh terminal and is connected to the terminal 414D of the switch 41E.

With this connection configuration, the switch 44 can selectively connect the terminal 441 to the terminals 442 and 443 based on, for example, a control signal from the RFIC 3. In other words, the switch 44 can exclusively connect the terminal 441 to one of the terminals 442 and 443.

In the present variation, the low-noise amplifier 23 and the radio frequency output terminal 122 are not necessarily included in the radio frequency circuit 1E. In this case, the filter 35 may be connected to the input end of the low-noise amplifier 21 via a switch. Also, the switch connected between the filter 35 and the low-noise amplifier 21 may be included in the switch 44.

In the present variation, the filter 33 and the switch 42E are not necessarily included in the radio frequency circuit 1E. In this case, similarly to FIG. 15, the filter 31 may be connected to the output end of the power amplifier 11 without using the switch 42E.

### [3.5 Modes of Radio Frequency Circuit 1E]

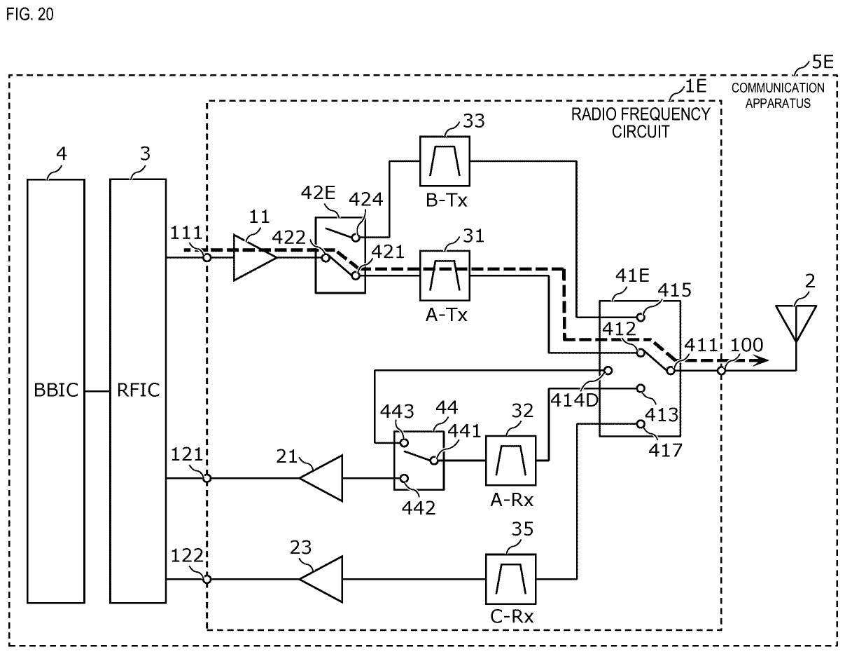

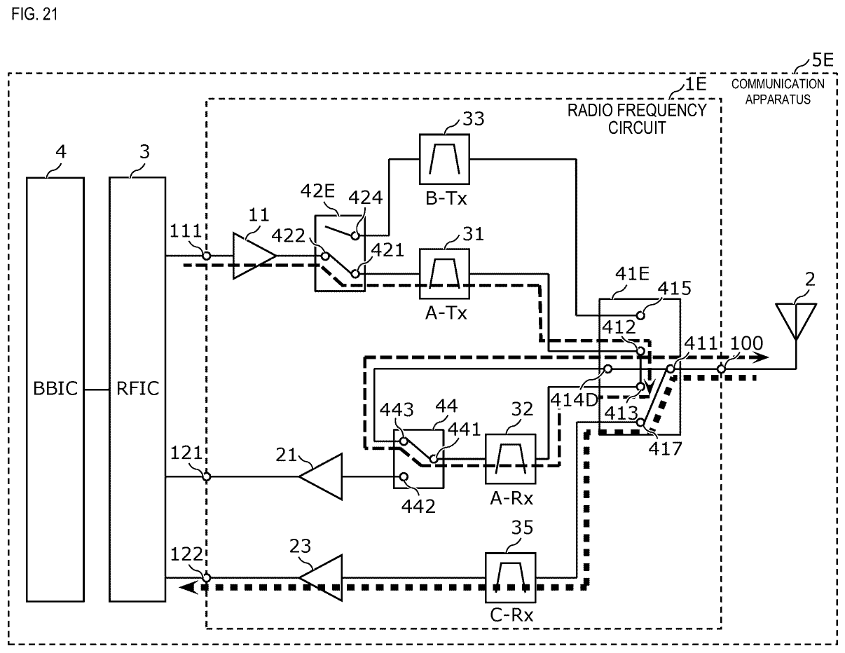

Next, a first mode and a third mode of the radio frequency circuit 1E are described with reference to FIGS. 20 and 21. FIG. 20 illustrates a path of a radio frequency signal in the first mode of the radio frequency circuit 1E according to the present variation. FIG. 21 illustrates a path of a radio frequency signal in the third mode of the radio frequency circuit 1E according to the present variation. In FIGS. 20 and 21, each dotted arrow represents a transmission path or a reception path of a radio frequency signal.

As illustrated in FIG. 20, the radio frequency circuit 1E is controlled in the first mode assuming a signal in the band A is transmitted and no signal in the band C is received. In the first mode, the filter 31 is connected, but the filter 32 is not connected, between the antenna connection terminal 100 and the radio frequency input terminal 111. Specifically, in the switch 41E, the terminal 411 is connected to the terminal 412 but is not connected to the terminals 413, 414D, 415, and 417. Also, the terminal 412 is not connected to the terminal 413. In the switch 42E, the terminal 422 is connected to the terminal 421 but is not connected to the terminal 424. In the switch 44, no terminal is connected to any other terminal.

In this mode, a transmission signal in the band A received from the RFIC 3 via the radio frequency input terminal 111 is transmitted to the antenna connection terminal 100 via the power amplifier 11, the switch 42E, the filter 31, and the switch 41E.

As illustrated in FIG. 21, the radio frequency circuit 1E is controlled in the third mode assuming a signal in the band A is transmitted and a signal in the band C is received. In the third mode, the filters 31 and 32 are connected in series between the antenna connection terminal 100 and the radio frequency input terminal 111. Specifically, in the switch 41E, the terminal 411 is connected to the terminal 414D and 417 but is not connected to the terminals 412, 413, and 415. Also, the terminal 412 is connected to the terminal 413. In the switch 42E, the terminal 422 is connected to the terminal 421 but is not connected to the terminal 424. In the switch 44, the terminal 441 is connected to the terminal 443 but is not connected to the terminal 442.

In this mode, a transmission signal in the band A received from the RFIC 3 via the radio frequency input terminal 111 is transmitted to the antenna connection terminal 100 via the power amplifier 11, the switch 42E, the filter 31, the switch 41E, the filter 32, the switch 44, and the switch 41E. Also, a reception signal in the band C received from the antenna 2 via the antenna connection terminal 100 is transmitted to the radio frequency output terminal 122 via the switch 41E, the filter 35, and the low-noise amplifier 23.

Thus, in the present variation, the first mode (FIG. 20) is used assuming a signal in the band A is transmitted and no signal in the band C is received. On the other hand, the third mode (FIG. 21) is used assuming a signal in the band A is transmitted and a signal in the band C is received. That is, in the radio frequency circuit 1E, (i) the first mode is used assuming reception in the band A is performed solely, and (ii) the third mode is used assuming reception in the band A and transmission in the band C are performed simultaneously.

In the radio frequency circuit 1E, similarly to FIG. 17, a second mode for performing only reception in the band A may also be used. Also, a mode for performing only transmission in the band B and/or a mode for performing only reception in the band C may also be used. Furthermore, a mode for simultaneously performing reception in the band A and transmission in the band B may be used.

### [3.6 Effects]

For example, the radio frequency circuit 1E according to the present variation further includes the filter 35 with a pass band including at least a part of the band C that can be used simultaneously with the band A for communication, and the switch 41E further includes the terminal 417 connected to the first end of the filter 35.

With this configuration, the radio frequency circuit 1E can support, in addition to the band A, the band C that can be used simultaneously with the band A for communication.

Also, for example, in the radio frequency circuit 1E according to the present variation, assuming a signal in the band A is transmitted and no signal in the band C is received, the switch 41E may connect the terminal 411 to the terminal 412; and assuming a signal in the band A is transmitted and a signal in the band C is received, (i) the switch 41E may connect the terminal 411 to the terminals 414D and 417 and connect the terminal 412 to the terminal 413, and (ii) the switch 44 may connect the terminal 441 to the terminal 443.

With this configuration, assuming transmission of a signal in the band A and reception of a signal in the band C are performed simultaneously, the filters 31 and 32 are connected in series to the transmission path. Therefore, this configuration makes it possible to improve the attenuation characteristics of the band C in a transmission path for the band A and to suppress the degradation of NF of a reception signal in the band C due to simultaneous communication. On the other hand, assuming transmission of a signal in the band A is performed solely, the filter 32 is not connected to the transmission path. Accordingly, assuming NF is not expected to be degraded due to simultaneous communication, an increase in signal loss due to the use of the two filters 31 and 32 can be prevented.

### OTHER EMBODIMENTS

Radio frequency circuits according to embodiments of the present disclosure and variations of the embodiments are described above. However, the present disclosure is not limited to the radio frequency circuits of the embodiments and the variations described above. The present disclosure may also include other embodiments implemented by combining components in the above embodiments and variations, other variations obtained by making various modifications conceivable by a person skilled in the art to the embodiments and variations without departing from the spirit of the present disclosure, and various devices including the radio frequency circuits described above.

For example, in the circuit configurations of the radio frequency circuits according to the above embodiments, another circuit element and/or a wire may be inserted in a path connecting circuit elements and signal paths illustrated in the drawings. For example, in a radio frequency circuit, an impedance matching circuit may be inserted between a power amplifier and/or a low-noise amplifier and a filter.

Features of the radio frequency circuits described in the above embodiments are listed below.
<1> A radio frequency circuit includes a first filter with a pass band including at least a part of a first band for time division duplex; a second filter with a pass band including at least a part of the first band; and a switch circuit that has (i) a first mode in which the first filter is connected between an antenna connection terminal and a radio frequency input terminal, (ii) a second mode in which the second filter is connected between the antenna connection terminal and a radio frequency output terminal, and (iii) a third mode in which the first filter and the second filter are connected in series between the antenna connection terminal and the radio frequency input terminal or between the antenna connection terminal and the radio frequency output terminal.
<2> The radio frequency circuit described in <1>. The switch circuit includes a first switch, a second switch, and a third switch; the first switch includes a first terminal connected to the antenna connection terminal, a second terminal connected to a first end of the first filter, a third terminal connected to a first end of the second filter, and a fourth terminal connected to the third switch; the second switch includes a fifth terminal connected to a second end of the first filter, a sixth terminal connected to the radio frequency input terminal, and a seventh terminal connected to the third switch; and the third switch includes an eighth terminal connected to a second end of the second filter, a ninth terminal connected to the radio frequency output terminal, a tenth terminal connected to the seventh terminal of the second switch, and an eleventh terminal connected to the fourth terminal of the first switch.
<3> The radio frequency circuit described in <2>. The first switch is capable of connecting the first terminal to the second terminal and the third terminal and connecting the fourth terminal to the second terminal; the second switch is capable of connecting the fifth terminal to the sixth terminal and the seventh terminal; and the third switch is capable of connecting the eighth terminal to the ninth terminal and the tenth terminal and connecting the eleventh terminal to the ninth terminal.
<4> The radio frequency circuit described in <3>. In the first mode, the first switch connects the first terminal to the second terminal, and the second switch connects the fifth terminal to the sixth terminal; in the second mode, the first switch connects the first terminal to the third terminal, and the third switch connects the eighth terminal to the ninth terminal; and in the third mode, the first switch connects the first terminal to the third terminal and connects the fourth terminal to the second terminal, the second switch connects the fifth terminal to the seventh terminal, and the third switch connects the eighth terminal to the tenth terminal and connects the eleventh terminal to the ninth terminal.
<5> The radio frequency circuit described in any one of <2> to <4> further includes a third filter with a pass band including at least a part of a second band that is usable simultaneously with the first band for communication. The first switch further includes a twelfth terminal connected to a first end of the third filter; and the second switch further includes a thirteenth terminal connected to a second end of the third filter.
<6> The radio frequency circuit described in <5>. Assuming a signal in the first band is received and no signal in the second band is transmitted, (i) the first switch connects the first terminal to the third terminal, and (ii) the third switch connects the eighth terminal to the ninth terminal. Assuming a signal in the first band is received and a signal in the second band is transmitted, (i) the first switch connects the first terminal to the third terminal and the twelfth terminal and connects the fourth terminal to the second terminal, (ii) the second switch connects the fifth terminal to the seventh terminal and connects the thirteenth terminal to the sixth terminal, and (iii) the third switch connects the eighth terminal to the tenth terminal and connects the eleventh terminal to the ninth terminal.
<7> The radio frequency circuit described in <1>. The switch circuit includes a first switch and a second switch; the first switch includes a first terminal connected to the antenna connection terminal, a second terminal connected to a first end of the first filter, a third terminal connected to a first end of the second filter, and a fourth terminal connected to the second switch; the second switch includes a fifth terminal connected to a second end of the first filter, a sixth terminal connected to the radio frequency input terminal, and a seventh terminal connected to the fourth terminal of the first switch; and the radio frequency output terminal is connected to a second end of the second filter.
<8> The radio frequency circuit described in <7>. The first switch is capable of connecting the first terminal to the second terminal and the third terminal and connecting the fourth terminal to the third terminal; and the second switch is capable of connecting the fifth terminal to the sixth terminal and the seventh terminal.
<9> The radio frequency circuit described in <8>. In the first mode, the first switch connects the first terminal to the second terminal, and the second switch connects the fifth terminal to the sixth terminal; in the second mode, the first switch connects the first terminal to the third terminal; and in the third mode, the first switch connects the first terminal to the second terminal and connects the fourth terminal to the third terminal, and the second switch connects the fifth terminal to the seventh terminal.
<10> The radio frequency circuit described in any one of <7> to <9> further includes a third filter with a pass band including at least a part of a second band that is usable simultaneously with the first band for communication. The first switch further includes an eighth terminal connected to a first end of the third filter, and the second switch further includes a ninth terminal connected to a second end of the third filter.
<11> The radio frequency circuit described in <10>. Assuming a signal in the first band is received and no signal in the second band is transmitted, the first switch connects the first terminal to the third terminal; and assuming a signal in the first band is received and a signal in the second band is transmitted, (i) the first switch connects the first terminal to the second terminal and the eighth terminal and connects the fourth terminal to the third terminal, and (ii) the second switch connects the fifth terminal to the seventh terminal and connects the ninth terminal to the sixth terminal.
<12> The radio frequency circuit described in <1>. The switch circuit includes a first switch and a second switch; the first switch includes a first terminal connected to the antenna connection terminal, a second terminal connected to a first end of the first filter, a third terminal connected to a first end of the second filter, and a fourth terminal connected to the second switch; the second switch includes a fifth terminal connected to a second end of the second filter, a sixth terminal connected to the radio frequency output terminal, and a seventh terminal connected to the fourth terminal of the first switch; and a second end of the first filter is connected to the radio frequency input terminal.
<13> The radio frequency circuit described in <12>. The first switch is capable of connecting the first terminal to the second terminal, the third terminal, and the fourth terminals and connecting the second terminal to the third terminal; and the second switch is capable of connecting the fifth terminal to the sixth terminal and the seventh terminal.
<14> The radio frequency circuit described in <13>. In the first mode, the first switch connects the first terminal to the second terminal; in the second mode, the first switch connects the first terminal to the third terminal, and the second switch connects the fifth terminal to the sixth terminal; and in the third mode, the first switch connects the first terminal to the fourth terminal and connects the second terminal to the third terminal, and the second switch connects the fifth terminal to the seventh terminal.
<15> The radio frequency circuit described in any one of <12> to <14> further includes a fourth filter with a pass band including at least a part of a third band that is usable simultaneously with the first band for communication. The first switch further includes an eighth terminal connected to a first end of the fourth filter.
<16> The radio frequency circuit described in <15>. Assuming a signal in the first band is transmitted and no signal in the third band is received, the first switch connects the first terminal to the second terminal; and assuming a signal in the first band is transmitted and a signal in the third band is received, (i) the first switch connects the first terminal to the fourth terminal and the eighth terminal and connects the second terminal to the third terminal, and (ii) the second switch connects the fifth terminal to the seventh terminal.
<17> The radio frequency circuit described in any one of <1> to <16>. (i) In the first mode, the switch circuit does not connect the second filter between the antenna connection terminal and the radio frequency input terminal; and (ii) in the second mode, the switch circuit does not connect the first filter between the antenna connection terminal and the radio frequency output terminal.
<18> A radio frequency circuit includes a first filter with a pass band including at least a part of a first band for time division duplex; a second filter with a pass band including at least a part of the first band; and first, second, and third switches. The first switch includes a first terminal connected to an antenna connection terminal, a second terminal connected to a first end of the first filter, a third terminal connected to a first end of the second filter, and a fourth terminal connected to the third switch. The second switch includes a fifth terminal connected to a second end of the first filter, a sixth terminal connected to a radio frequency input terminal, and a seventh terminal connected to the third switch. The third switch includes an eighth terminal connected to a second end of the second filter, a ninth terminal connected to a radio frequency output terminal, a tenth terminal connected to the seventh terminal of the second switch, and an eleventh terminal connected to the fourth terminal of the first switch.
<19> A radio frequency circuit includes a first filter with a pass band including at least a part of a first band for time division duplex; a second filter with a pass band including at least a part of the first band; and first and second switches. The first switch includes a first terminal connected to an antenna connection terminal, a second terminal connected to a first end of the first filter, a third terminal connected to a first end of the second filter, and a fourth terminal connected to the second switch. The second switch includes a fifth terminal connected to a second end of the first filter, a sixth terminal connected to a radio frequency input terminal, and a seventh terminal connected to the fourth terminal of the first switch. A second end of the second filter is connected to a radio frequency output terminal.

### INDUSTRIAL APPLICABILITY

The present disclosure can be widely used for communication devices, such as mobile phones, as a switch circuit or a radio frequency circuit disposed in a front-end unit.

### REFERENCE SIGNS LIST

1, 1A, 1B, 1C, 1D, 1E radio frequency circuit
2 antenna
3 RFIC
4 BBIC
5, 5A, 5B, 5C, 5D, 5E communication apparatus
11 power amplifier
21, 22, 23 low-noise amplifier
31, 32, 33, 34, 35 filter
41, 41A, 41B, 41C, 41D, 41E, 42, 42A, 42B, 42C, 42E, 43, 43A, 43C, 44 switch
100 antenna connection terminal
111 radio frequency input terminal
121, 122 radio frequency output terminal
411, 412, 413, 414, 414B, 414D, 415, 416, 417, 421, 422, 423, 423B, 424, 431, 432, 433, 434, 435, 441, 442, 443 terminal

1. A radio frequency circuit comprising:
a first filter with a pass band including at least a part of a first band for time division duplex;
a second filter with a pass band including at least a part of the first band; and
a switch circuit that has (i) a first mode in which the first filter is connected between an antenna connection terminal and a radio frequency input terminal, (ii) a second mode in which the second filter is connected between the antenna connection terminal and a radio frequency output terminal, and (iii) a third mode in which the first filter and the second filter are connected in series between the antenna connection terminal and the radio frequency input terminal or between the antenna connection terminal and the radio frequency output terminal.

2. The radio frequency circuit according to claim 1, wherein
the switch circuit includes a first switch, a second switch, and a third switch;
the first switch includes a first terminal connected to the antenna connection terminal, a second terminal connected to a first end of the first filter, a third terminal connected to a first end of the second filter, and a fourth terminal connected to the third switch;
the second switch includes a fifth terminal connected to a second end of the first filter, a sixth terminal connected to the radio frequency input terminal, and a seventh terminal connected to the third switch; and
the third switch includes an eighth terminal connected to a second end of the second filter, a ninth terminal connected to the radio frequency output terminal, a tenth terminal connected to the seventh terminal of the second switch, and an eleventh terminal connected to the fourth terminal of the first switch.

3. The radio frequency circuit according to claim 2, wherein
the first switch is capable of connecting the first terminal to the second terminal and the third terminal and connecting the fourth terminal to the second terminal;
the second switch is capable of connecting the fifth terminal to the sixth terminal and the seventh terminal; and
the third switch is capable of connecting the eighth terminal to the ninth terminal and the tenth terminal and connecting the eleventh terminal to the ninth terminal.

4. The radio frequency circuit according to claim 3, wherein
in the first mode, the first switch connects the first terminal to the second terminal, and the second switch connects the fifth terminal to the sixth terminal;
in the second mode, the first switch connects the first terminal to the third terminal, and the third switch connects the eighth terminal to the ninth terminal; and
in the third mode, the first switch connects the first terminal to the third terminal and connects the fourth terminal to the second terminal, the second switch connects the fifth terminal to the seventh terminal, and the third switch connects the eighth terminal to the tenth terminal and connects the eleventh terminal to the ninth terminal.

5. The radio frequency circuit according to claim 4, further comprising:
a third filter with a pass band including at least a part of a second band that is usable simultaneously with the first band for communication, wherein
the first switch further includes a twelfth terminal connected to a first end of the third filter; and
the second switch further includes a thirteenth terminal connected to a second end of the third filter.

6. The radio frequency circuit according to claim 5, wherein
assuming a signal in the first band is received and no signal in the second band is transmitted, (i) the first switch connects the first terminal to the third terminal, and (ii) the third switch connects the eighth terminal to the ninth terminal; and
assuming a signal in the first band is received and a signal in the second band is transmitted, (i) the first switch connects the first terminal to the third terminal and the twelfth terminal and connects the fourth terminal to the second terminal, (ii) the second switch connects the fifth terminal to the seventh terminal and connects the thirteenth terminal to the sixth terminal, and (iii) the third switch connects the eighth terminal to the tenth terminal and connects the eleventh terminal to the ninth terminal.

7. The radio frequency circuit according to claim 1, wherein
the switch circuit includes a first switch and a second switch;
the first switch includes a first terminal connected to the antenna connection terminal, a second terminal connected to a first end of the first filter, a third terminal connected to a first end of the second filter, and a fourth terminal connected to the second switch;
the second switch includes a fifth terminal connected to a second end of the first filter, a sixth terminal connected to the radio frequency input terminal, and a seventh terminal connected to the fourth terminal of the first switch; and
the radio frequency output terminal is connected to a second end of the second filter.

8. The radio frequency circuit according to claim 7, wherein
the first switch is capable of connecting the first terminal to the second terminal and the third terminal and connecting the fourth terminal to the third terminal; and
the second switch is capable of connecting the fifth terminal to the sixth terminal and the seventh terminal.

9. The radio frequency circuit according to claim 8, wherein
in the first mode, the first switch connects the first terminal to the second terminal, and the second switch connects the fifth terminal to the sixth terminal;
in the second mode, the first switch connects the first terminal to the third terminal; and
in the third mode, the first switch connects the first terminal to the second terminal and connects the fourth terminal to the third terminal, and the second switch connects the fifth terminal to the seventh terminal.

10. The radio frequency circuit according to claim 9, further comprising:
a third filter with a pass band including at least a part of a second band that is usable simultaneously with the first band for communication, wherein
the first switch further includes an eighth terminal connected to a first end of the third filter; and
the second switch further includes a ninth terminal connected to a second end of the third filter.

11. The radio frequency circuit according to claim 10, wherein
assuming a signal in the first band is received and no signal in the second band is transmitted, the first switch connects the first terminal to the third terminal; and
assuming a signal in the first band is received and a signal in the second band is transmitted, (i) the first switch connects the first terminal to the second terminal and the eighth terminal and connects the fourth terminal to the third terminal, and (ii) the second switch connects the fifth terminal to the seventh terminal and connects the ninth terminal to the sixth terminal.

12. The radio frequency circuit according to claim 1, wherein
the switch circuit includes a first switch and a second switch;
the first switch includes a first terminal connected to the antenna connection terminal, a second terminal connected to a first end of the first filter, a third terminal connected to a first end of the second filter, and a fourth terminal connected to the second switch;
the second switch includes a fifth terminal connected to a second end of the second filter, a sixth terminal connected to the radio frequency output terminal, and a seventh terminal connected to the fourth terminal of the first switch; and
a second end of the first filter is connected to the radio frequency input terminal.

13. The radio frequency circuit according to claim 12, wherein
the first switch is capable of connecting the first terminal to the second terminal, the third terminal, and the fourth terminals and connecting the second terminal to the third terminal; and
the second switch is capable of connecting the fifth terminal to the sixth terminal and the seventh terminal.

14. The radio frequency circuit according to claim 13, wherein
in the first mode, the first switch connects the first terminal to the second terminal;
in the second mode, the first switch connects the first terminal to the third terminal, and the second switch connects the fifth terminal to the sixth terminal; and
in the third mode, the first switch connects the first terminal to the fourth terminal and connects the second terminal to the third terminal, and the second switch connects the fifth terminal to the seventh terminal.

15. The radio frequency circuit according to claim 14, further comprising:
a fourth filter with a pass band including at least a part of a third band that is usable simultaneously with the first band for communication, wherein
the first switch further includes an eighth terminal connected to a first end of the fourth filter.

16. The radio frequency circuit according to claim 15, wherein
assuming a signal in the first band is transmitted and no signal in the third band is received, the first switch connects the first terminal to the second terminal; and
assuming a signal in the first band is transmitted and a signal in the third band is received, (i) the first switch connects the first terminal to the fourth terminal and the eighth terminal and connects the second terminal to the third terminal, and (ii) the second switch connects the fifth terminal to the seventh terminal.

17. The radio frequency circuit according to claim 16, wherein
(i) in the first mode, the switch circuit does not connect the second filter between the antenna connection terminal and the radio frequency input terminal; and
(ii) in the second mode, the switch circuit does not connect the first filter between the antenna connection terminal and the radio frequency output terminal.

18. A radio frequency circuit comprising:
a first filter with a pass band including at least a part of a first band for time division duplex;
a second filter with a pass band including at least a part of the first band; and
first, second, and third switches, wherein
the first switch includes a first terminal connected to an antenna connection terminal, a second terminal connected to a first end of the first filter, a third terminal connected to a first end of the second filter, and a fourth terminal connected to the third switch;
the second switch includes a fifth terminal connected to a second end of the first filter, a sixth terminal connected to a radio frequency input terminal, and a seventh terminal connected to the third switch; and
the third switch includes an eighth terminal connected to a second end of the second filter, a ninth terminal connected to a radio frequency output terminal, a tenth terminal connected to the seventh terminal of the second switch, and an eleventh terminal connected to the fourth terminal of the first switch.

19. A radio frequency circuit comprising:
a first filter with a pass band including at least a part of a first band for time division duplex;
a second filter with a pass band including at least a part of the first band; and
first and second switches, wherein
the first switch includes a first terminal connected to an antenna connection terminal, a second terminal connected to a first end of the first filter, a third terminal connected to a first end of the second filter, and a fourth terminal connected to the second switch;
the second switch includes a fifth terminal connected to a second end of the first filter, a sixth terminal connected to a radio frequency input terminal, and a seventh terminal connected to the fourth terminal of the first switch; and
a second end of the second filter is connected to a radio frequency output terminal.

20. The radio frequency circuit according to claim 1, wherein
(i) in the first mode, the switch circuit does not connect the second filter between the antenna connection terminal and the radio frequency input terminal; and
(ii) in the second mode, the switch circuit does not connect the first filter between the antenna connection terminal and the radio frequency output terminal.
